(19) United States
(12) Patent Application Publication
(10) Pub. No.: US 2003/0061607 A1
(43) Pub. Date: Mar. 27, 2003

(54) Systems and methods for providing consumers with entertainment content and associated periodically updated advertising

(76) Inventors: Charles Eric Hunter, Hilton Head, SC (US); Bernard L. Ballou JR., Raleigh, NC (US); Kelly C. Sparks, Morrisville, NC (US); Bennie Gibson, Mabelton, GA (US); Randy Daniel, Raleigh, NC (US); Greg Hodge, Cary, NC (US); John Hebrank, Durham, NC (US)

Correspondence Address: Finnegan, Henderson, Farabow,, Garrett & Dunner, L.L.P., 1300 I Street, N.W., Washington, DC, 20005-3315, US

(21) Appl. No.: 10/210,823

(22) Filed: Aug. 2, 2002

Related U.S. Application Data
(63) Continuation-in-part of application No. 10/072,471, filed on Feb. 7, 2002.
(63) Continuation-in-part of application No. 10/035,172, filed on Jan. 4, 2002.
(63) Continuation-in-part of application No. 09/781,679, filed on Feb. 12, 2001.
(63) Continuation-in-part of application No. 09/781,680, filed on Feb. 12, 2001.
(60) Provisional application No. 60/322,186, filed on Sep. 14, 2001.
(60) Provisional application No. 60/322,187, filed on Sep. 14, 2001.
(60) Provisional application No. 60/325,888, filed on Sep. 28, 2001.
(60) Provisional application No. 60/326,563, filed on Oct. 2, 2001.
(60) Provisional application No. 60/328,606, filed on Oct. 11, 2001.
(60) Provisional application No. 60/347,440, filed on Nov. 7, 2001.
(60) Provisional application No. 60/382,622, filed on May 24, 2002.

(51) Int. Cl. H04N 7/025; H04N 7/10; G06F 3/00; H04N 5/445; G06F 13/00; H04N 7/16

(52) U.S. Cl. 725/32; 725/34; 725/61; 725/136

(57) ABSTRACT

A player device for generating audio visual signals representative of entertainment content with advertisements includes a reader mechanism for reading entertainment content pre-recorded on a first medium and reading advertisements pre-recorded on a second medium, and a processor generating command signals inserting advertisements read by the reader mechanism from the second medium into entertainment content read by the reader mechanism from the first medium.

### CROSS REFERENCE TO RELATED APPLICATIONS

This application is a Continuation-In-Part of U.S. patent application Ser. No.10/072,471, for “Systems and Methods for Providing Consumers with Entertainment Content and Associated Periodically Updated Advertising,” filed Feb. 7, 2002 (Reference number WT-28); U.S. patent application Ser. No. 10/035,172, for “Systems and Methods for Distribution of Entertainment and Advertising Content,” filed Jan. 4, 2002 (Reference number WT-27); U.S. patent application Ser. No. 09/781, 679, for “Video Distribution System,” filed Feb. 12, 2001 (Reference WT-15); and U.S. patent application Ser. No. 09/781,680, “Video Distribution System,” filed Feb. 12, 2001 (Reference number WT-16), and all of which are assigned to the assignee of the present application. The disclosures of the aforementioned U.S. patent applications are hereby expressly incorporated herein by reference.

This Application further claims priority to U.S. Provisional Application No. 60/322,186, for “Ultrahigh Reliability, High Density Read and Write Data Storage System,” filed Sep. 14, 2001 (Reference number WT-19), the contents of which are expressly incorporated herein by reference.

This Application further claims priority to U.S. Provisional Application No. 60/322,187, for “System and Method for Content Delivery,” filed Sep. 14, 2001 (Reference number WT-20), the contents of which are expressly incorporated herein by reference.

This Application further claims priority to U.S. Provisional Application No. 60/325,888, for “System and Method for Ultrahigh Reliability, High Density, Short Wavelength Laser Read and Write Data Storage System With Content Protection,” filed Sep. 28, 2001, (Reference number WT-22), the contents of which are expressly incorporated herein by reference.

This application further claims priority to U.S. Provisional Application No. 60/326,563, for “System and Method for Ultrahigh Reliability, High Density, Short Wavelength Laser Read and Write Data Storage System With Content Protection,” filed Oct. 2, 2001 (Reference number WT-21), the contents of which are expressly incorporated herein by reference.

This Application further claims priority to U.S. Provisional Application, Serial No. 60/328,606, for “System and Method for Optically Altered DVD (DVDOTM),” filed Oct. 11, 2001 (Reference number WT-24), the contents of which are expressly incorporated herein by reference.

This Application further claims priority to U.S. Provisional Application, Serial No. 60/347,440, for “System and Method for Optically Altered DVD (DVDO™),” filed Nov. 7, 2001 (Reference number WT-25), the contents of which are expressly incorporated herein by reference.

This application further claims priority to U.S. Provisional Application, Serial No. 60/382,622, for “Methods and Apparatus for Video Watermarking,” filed May 24, 2002 (Reference number WT-30), the contents of which are expressly incorporated herein by reference.

### DESCRIPTION

1. Field

This invention relates to systems and methods for providing consumers with entertainment content and advertising content. In certain embodiments, the invention relates to distributing in-home, on-demand entertainment content such as movies and music selections, preferably coupled with periodically updated advertising.

2. Background

The current size and success of the entertainment industry shows the enormous market for audio and video entertainment by consumers. The music recording industry, television and movie industries, and professional athletics, among others, have all seen large economic gains since the dawn of television and radio. In fact, the demand for such broadcast audio and visual content spawned new for a for advertising. However, current methodologies for the distribution and viewing of audio/visual content including music, movies, information, and advertising have become outdated due to substantial steps forward in technology.

Traditionally, consumers, i.e., those watching or listening to the audio/visual content, were forced to view or listen to the content as it was broadcast. Television stations followed specific schedules to let consumers know when their show, movies, information or sporting events would be broadcast. In addition, radio stations broadcast the music or shows according to their set schedules. As a result, the consumer had very little flexibility in deciding when to view their show, or listen to their music. Similarly advertisers were restricted by the schedule to broadcast their advertisements at whatever affordable, available time was most likely to include viewers interested in their products. The system was neither efficient for the advertisers nor convenient for the consumers.

As a result, techniques developed to allow the consumer to record the music or movie from the broadcast for later viewing or listening. Audio cassettes allowed for the capture of audio content. VCR's allowed the consumer to capture audio visual content. In addition, models such as those employed by TiVo and Replay allowed for the capture of such content for later viewing. However, these models required the viewer to know in advance the scheduled broadcast time for their show and to program a device, such as a VCR to record their shows. This required additional cost for the recording device and medium, and time to study the broadcast schedule and to program the recording device accordingly. This scheme, however, adversely impacted advertisers, as consumers watching the recorded content often fast forwarded past any advertisements.

Movie rental stores allow users to rent pre-recorded movies for at-home play, subject to pick-up and return trips to the rental store, availability of movies at the store, and costs and inconvenience associated with lost or damaged media and late returns. Furthermore, movie advertisements (“previews”) contained on the rented movies are locked in time and thereby limited to those upcoming movies at the time the movie is recorded to the medium. Viewers of the pre-recorded movies months or years later are subjected to long outdated previews of little value to them or the advertiser (the movie studio).

More recently, video on demand (or audio on demand) has allowed consumers the ability to modify the schedule of the audio/visual content by simply demanding content at times convenient to the consumer. This technique suffered from two profound limitations. First, the content distributed in this scheme was easily copied and disseminated without the consent of the content providers. In addition, advertisers were further limited in their options, as they now may not even chose the broadcast time for their commercials. Instead, they were limited to transmission of the advertisements at the time demanded by the consumer.

Another limitation of current content distribution schemes is that Digital Rights Management (DRM) schemes are digitally implemented. As technology advances, the processing power available for decryption, collaborative distributed processing efforts such as those utilized to break DES (digital encryption system), have minimized the security of existing DRM models. In addition, the publication of software applications such as DeCSS for cracking DVD, and the availability of unencrypted formats, render the cryptographic analysis of digital keys possible. As a result, estimates place lost revenues due to copied VHS recordings at roughly 30%. Furthermore, in emerging markets such as China, the estimates soar to nearly 80%. Estimates of the loss due to ripped CD's and DVD's are difficult to estimate presently.

It is desirable, therefore to provide a distribution scheme for delivery of audio and video content with increased security and convenience, and higher density (i.e. greater data per disc). In addition, the method should provide the ability to archive audio and video content on secure discs for consumers to view at their convenience. In addition, it is desirable that the method provide the ability to couple fresh, periodically updated advertisements with the audio and video content, even when a consumer is enjoying content that he has had archived in his home for months or years. Also, it is desirable that the method provide the ability to better target advertisements to the wants and needs of the consumers who will be watching them.

Current industry practices require complex alliances and strategies for the production and distribution of movies, musical recordings and other content. For example, film actors, independent film makers, and music recording artists find themselves generally unable to reach consumers without forging alliances with movie studios or record companies and other players in the chain between the artist and the consumer. These time-honored practices, suitable to an earlier era, have a debilitating effect on the production and distribution of entertainment content. For example, owing in large part to the cost of distribution, the number of major films released in the United States has dropped from approximately 300 films in 1995 to approximately 150 films in 2000. In a self-defeating cycle, films are evermore expensive, making each film a bigger risk. In an effort perceived to lower the risk, those involved feel a need to use more expensive big-name movie stars who may be compensated at ten million dollars per film, and more. It would be desirable to have an alternative system and method for distributing content to consumers, removing many of the players who currently stand between film actors, independent film makers, and music recording artists. This will encourage a vast increase in offerings of movies, music recordings, and other content at lower prices, while opening up new opportunities for emerging artists. Such a new paradigm will permit both established artists and other artists essentially to go directly to the consumer with the aid of appropriate financial and production services from venture capitalists and the like.

### SUMMARY

A player device for generating audio visual signals representative of entertainment content with advertisements includes a reader mechanism for reading entertainment content pre-recorded on a first medium and reading advertisements pre-recorded on a second medium, and a processor generating command signals inserting advertisements read by the reader mechanism from the second medium into entertainment content read by the reader mechanism from the first medium. The advertisements read from the second medium may be inserted at the beginning or end of the entertainment content, or the advertisements may be interspersed within the entertainment content.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments and together with the description, serve to explain the principles of the invention.

FIG. 1 is a block diagram showing a distribution model for distributing audiovisual content and advertising content to consumers;

FIG. 2 is a flowchart depicting the stages for inserting advertisements into viewed content;

FIG. 3 is a flowchart depicting the stages for consumers to select the order in which the entertainment content is viewed;

FIG. 4 is a block diagram of a set top box including a pair of optical readers, one for the entertainment content and one for updated advertisements (and, optionally, a current content index);

FIG. 5 is a block diagram showing a vendor independent design of the dual drive set top box;

FIG. 6 is a block diagram showing a side view of a disc;

FIG. 7 is a diagram depicting a top-view of a disc;

FIG. 8 is a schematic representation of a portable player;

FIG. 9 is a block diagram showing the relationship between a portable player and a set top box.

FIG. 10 is a video tagging block diagram in which a watermark is inserted into video content during encoding consistent with the present invention;

FIG. 11 is another video tagging block diagram in which a watermark is inserted into video content during play-back/out using a video player and optionally a commerce server consistent with the present invention;

FIG. 12 is another video tagging block diagram in which a watermark is inserted into video content during play-back/out using a software player and a NTSC card and optionally a commerce server consistent with the present invention;

FIG. 13 is yet another video tagging block diagram in which a watermark is inserted into individual frames of the video content during playback using a player and optionally a commerce server consistent with the present invention;

FIGS. 14-17 is a series of video frames with embossed watermarks that have been inserted into video content consistent with the present invention;

FIG. 18 is a flowchart of a method for providing entertainment content to a projection system consistent with the present invention; and

FIG. 19 is a diagram of an embodiment of a media feed system consistent with the present invention.

### DETAILED DESCRIPTION

Reference will now be made in detail to exemplary embodiments, which are illustrated in the accompanying drawings. Wherever possible, the same reference numbers will, throughout the drawings, refer to the same or like parts.

A system and method provide for unrestricted distribution of protected content on a first medium, such as a content disc, to consumers, in a manner optimized to meet market conditions. Furthermore, consistent with the present invention, regularly updated advertisements are distributed to consumers on a second medium, such as an advertisement disc, that is shipped periodically, for example, monthly. The advertisement disc preferably includes an index to available and upcoming entertainment content. Each consumer also receives a disc player, or “set top box”, that is a relatively inexpensive device including a first reader for reading an entertainment content disc and a second reader for the then-current advertisement disc. Thus, consistent with the present invention, updated advertisements may be shown along with the entertainment content being viewed by the consumer. Advertisements may be targeted to consumers based on consumer preferences.

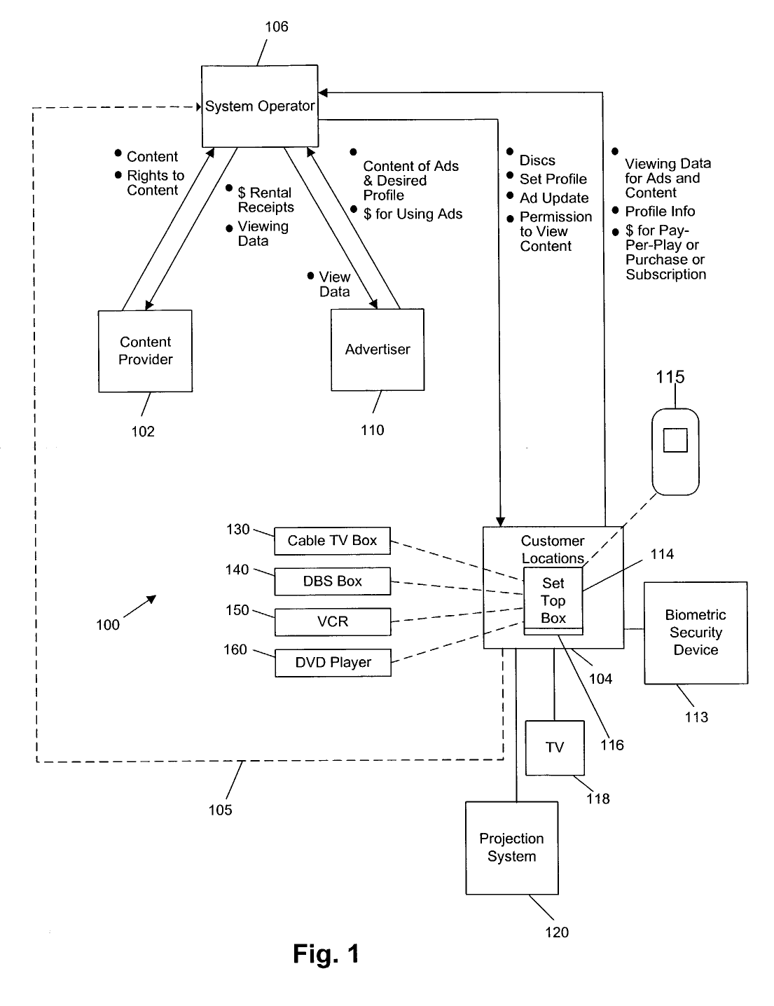

As shown in FIG. 1, the system 100 comprises one or more content providers 102, a plurality of consumer locations 104, a distribution system operator 106, and one or more advertisers 110. Consumer locations 104 will view the distributed content on a television receiver using a device such as a set top box 114, including capability to simultaneously or sequentially play multiple media. In another embodiment of the present invention, the distributed content may be viewed on a projection system 120 using set top box 114.

System 100 additionally may contain numerous communications links between the various components of the system, as will be described. Content provider 102 provides content (e.g., informational content such as shopping catalogs, video content such as movies or television shows, educational content such as course training materials, or audio content such as songs or radio shows) to consumer locations 104.

Consistent with the present invention, once one or more of consumer locations 104 register with system operator 106, content provider(s) 102, retailers, and/or system operator 106 may ship a “startup” package to the registered consumer locations 104. Such a startup package may include, for example (i) 5 movie discs containing 25 movies; (ii) three music discs containing 180 CDs/albums; (iii) the then-current advertisement disc (preferably also containing a content index as discussed below); and (iv) a set top box. The startup package may be shipped to the registered consumer locations 104 free of charge, or at a relatively nominal charge, for example, a charge not exceeding the cost of production and delivery.

After consumer locations 104 receive the startup package and complete a setup process, which may include communications verification between set top box 114 and system operator 106, the consumer may archive the content in his/her personal “library” and thereby has unlimited access to all content in the package, after access to the content is authorized. Additionally, entertainment content may be shipped monthly along with each month's new advertising disc. For example, on an ongoing basis, consumer locations 104 may receive a monthly package including (i) five movie discs (25 movies); (ii) one music disc (60 CDs/albums); iii) one or more educational content discs; and (iv) one advertising/index disc. For the purposes of this description, a library may be defined as an accumulation of the entertainment content that was originally delivered with set top box 114, the entertainment content shipped on a periodic basis to a consumer, entertainment content that is specially ordered, and/or the entertainment content that the consumer buys on a retail basis.

Additionally, the startup package sent to consumer locations 104 may include a shopping catalog disc containing catalogs of many of the largest catalog sales companies (e.g., L.L. Bean or J.C. Penney). The startup package may also includes catalogs which include a table of contents of all the possible volumes that are available with the various titles and other information representing the contents therein. The catalog disc may be replaced with an updated catalog disc on a periodic basis, for example, on a quarterly basis. For the purpose of this description, a catalog may be defined as a catalog from a sales company or as a catalog containing a table of contains of all the possible volumes that are available with the various titles and other information representing the contents therein.

The catalogs provided by provider 102 may contain a structure with collaborative links. Through these links, entertainment content may be related to content discs based on viewer choice(s). For example, if the consumer selects a first movie to view (e.g., “Almost Famous”), set top box 114 using a catalog may recognize that a disc with a second movie having the same viewer appeal as the first movie (e.g., “Diner”) is also in the catalog, and the second movie may be recommended with the disc number. Through the collaborative links, movie offerings may also be limited by viewer preferences. For example, if the consumer's preference is not to view R-rated movies, R-rated movies will not be presented in the consumer's viewing choices. The links in the structure may also be used to offer movies on discs not in the consumer's in-home library. The structure described above may also be applied to advertisements. For example, the collaborative links may be used for recommending other products of interest to a consumer that has selected a particular advertisement. The links for advertisements may be related to the characteristics of the advertisements as well as categories for advertisements. Consumer characteristics that are based on viewing habits, as well as other inputs, are used to determine the consumer categories for advertisements.

For the consumer to easily use the catalogs, set top box 114 may provide an interactive menu and navigational system to be displayed on a consumer television receiver to enable a consumer to scroll through content catalogs to seek available titles and to request a title using a remote control. The request for a content disc not currently in the consumer's library may be placed through a back channel connection 105 and the content disc will be shipped directly to the consumer's home.

Payment for a request may be accomplished by providing product numbers that identify the entertainment content. The product number may be overlaid on the video display with the associated catalog entry identifying the entertainment content. The consumer may use a remote control device 115 to select the product number and place the request for the entertainment content over back channel connection 105. Systems and methods for implementing an order processing system using product number identifiers may be implemented utilizing the systems and methods set forth in commonly assigned co-pending U.S. patent application Ser. No. 09/976,836, filed Oct. 24, 2001 (Reference number WT-3-CIP4), and co-pending U.S. patent application Ser. No. 09/645,086, filed Aug. 12, 2000 (Reference number WT-3-CIP3), which are incorporated by reference herein in their entireties.

The navigational system may also provide unique searches specialized to consumer preferences. The consumer preferences may be established by the consumer or deduced as a result of the title selections (and perhaps trailer selection), to predetermine the advertisements from the advertisement disc that may best match the consumer's household. The advertisement disc may contain information relating to pre-defined searches, pricing, categories, commercials, preferences, contests, games, surveys, and/or other electronic data.

In addition to ordering from a catalog, consumers may at any time order available content discs from the system operator for an established charge, typically not exceeding cost of production plus delivery. Optionally, content discs may also be obtained from other distribution agents such as retailers, catalog sales companies, or the like.

The content may be distributed in a protected format such that the distribution system operator may control access to the content and charge for any presentation of the content, either on a pay-per-view basis, a one-time fee, subscription or other basis. A mechanism may be provided to protect the content using hardware, software encryption, or both, to prevent unauthorized access to the content. The content may be hardware protected by distributing proprietary discs which are not readable by commercially available hardware such as PCs, CD or DVD players. Reading the disc may then require a proprietary set top box 114. To receive enabling commands or keys necessary to unlock any encrypted content, a consumer would remit payment to system operator 106.

The periodically shipped advertisement disc may be in the same protected format and same medium as the entertainment content discs. Alternately, the advertisement disc may be another medium, for example, conventional DVD or CD.

Consistent with certain embodiments of the present invention, set top box 114 includes at least two readers, each comprising a drive mechanism. When the consumer plays the distributed content via a first reader in set top box 114 an advertisement disc may reside in the second reader. At times before, during, or after playing of the entertainment content, set top box 114 causes advertisements from the advertisement disc to be presented on the screen of television 118. The advertisements may include current movie “previews,” in which case the advertiser 110 (FIG. 1) may be the same entity as the content provider 102. Commercial advertisements other than movie previews may also be displayed before, during, or after playing the entertainment content. Advertisements may be inserted at insertion points in a manner described herein.

Following viewing of content by a consumer, system operator 106 receives data regarding the viewings of advertisements, such as the number of viewings, and residential preference information via back channel 105 and sends this data to the advertiser. Such information allows advertiser 110 to modify its advertising approach (i.e., direct advertising campaigns to new preferences). Advertiser 110 may submit payment to system operator 106 and system operator 106 may submit viewing data, payment royalties, and/or rental receipts to content providers 102.

As stated above, the entertainment content may be distributed in the form of a secure storage medium. Traditional CDs and DVDs may be used, however, the limited storage capacity of traditional discs may require the distribution of an undesirably large quantity of such discs. In addition, it has become increasingly easy to pirate the content of such discs by “ripping” the contents from the disc, and decoding it using applications available over the Internet. Instead, high density secure media, such as optically altered DVDO's™, discussed below, are preferably used to securely distribute the content.

Therefore, once a consumer selects content for viewing, set top box 114 may present the desired content for display with the option of showing advertisements before, during, or after the show. The advertisements may be displayed when set top box 114 encounters “insertion points” embedded in the encoded content. As set top box 114 encounters these insertion points, it will insert an advertisement from the advertisement disc in the content stream being supplied to television 118 for presentation to the consumer.

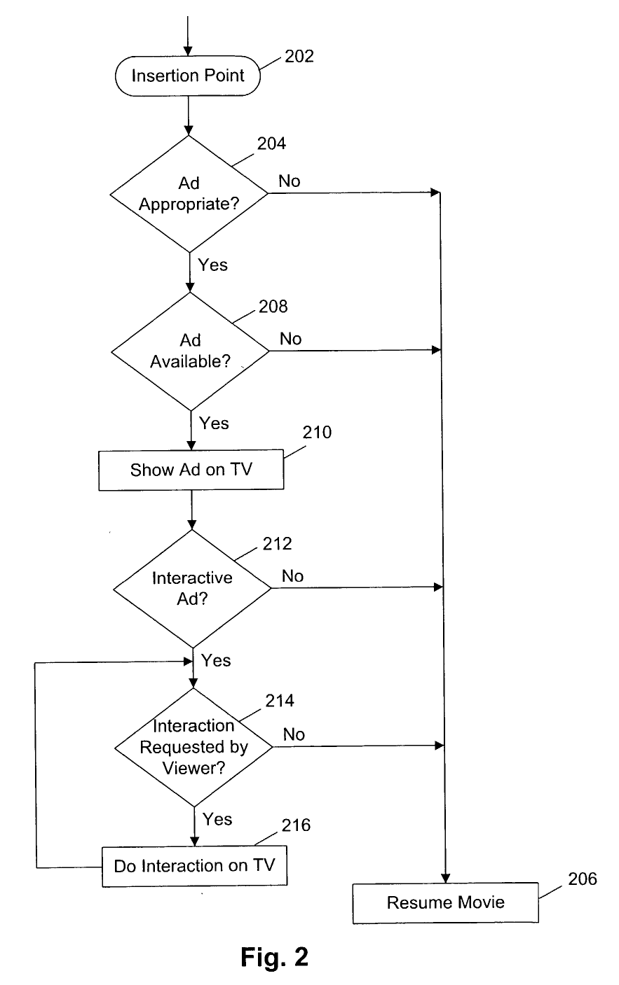

FIG. 2 shows an exemplary method for integrating advertisements at insertion points in the viewed content. As set top box 114 receives data via an entertainment content disc for presentation to the viewer, it will occasionally encounter insertion points. An insertion point may be a set of bytes in the content representative of a command to insert an advertisement in the presented content. Consistent with the invention, the command may comprise a pointer to the second reader mechanism containing the advertisements/index disc.

Once set top box 114 encounters such a command (Stage 202), it then determines whether an advertisement is appropriate (Stage 204). Consistent with principles of the present invention, a number of methods may be used to determine if the advertisement is appropriate. An advertisement may be appropriate: i) if the insertion point would be a logical place to insert an advertisement for the current residential preference at that consumer household; ii) if the rental or purchase is within a specified date range and the rental or purchase is linked, based on the type or title of the content being viewed, to a pre-recorded advertisement on the advertisement disc (e.g., season appropriate ads—winter clothes from pre-winter buy months through end of February); and iii) if the insertion point is at the beginning and/or end of the entertainment content being viewed and an advertisement is linked to the type of content and/or title for the entertainment content.

In addition to the above, to determine if an advertisement is appropriate, methods may be used for coordinating advertisements based upon environmental factors. For example, system operator 106 may monitor, or receive from an input source, temperature information and feed the temperature information to set top box 114. Based on the temperature information received, set top box 114 may run advertisements for thirst-quenching drinks on hot days and advertisements for hot chocolate on cold days.

On the other hand, an advertisement may be inappropriate if it would not make sense to advertise at that point in the content. An advertisement may not be appropriate if the consumer has paid a higher rate for the ability to view the content free of advertisements. The residential preference of the consumer may reside in the memory of set top box 114, or, in one embodiment, may reside on a host computer of the content provider or video distribution system operator. If set top box 114 determines that an advertisement is not appropriate, it simply resumes playing the content (Stage 206).

If, however, the insertion point is appropriate for an advertisement, then set top box 114 must determine if an advertisement is available for insertion (stage 208). In addition, the command to insert an advertisement may specify a location from which to retrieve the advertisement, or may allow set top box 114 to choose the advertisement based on a predefined algorithm, or based on residential preferences. If an advertisement is not available, set top box 114 may return to stage 206 to resume playing the content. In addition, the disc containing the content may contain a default advertisement or advertisements (such as to be chosen based on a consumer preference), in addition to the insertion command, which may be played if no appropriate advertisement is available.

Set top box 114 then plays the advertisement (Stage 210). In addition, the advertisement may be an interactive advertisement (Stage 212), in which case the advertisement will allow the user to interact via any known or later developed means (Stage 214). In addition, a user may enter commands by inputting commands through a remote control, or communicating via the internet to the advertiser (Stage 216).

Once set top box 114 has completed presentation of the advertisement, and any interaction, the advertisement may contain a return command, commanding set top box 114 to resume presentation of the content (Stage 206). Such a command allows advertisements to be any length, providing greater flexibility to advertisers.

As stated above, advertisements on the advertisement disc may be conventional sound and images as are currently shown on television, or may be interactive advertisements. In interactive advertisements the viewer can change the displayed material by expressing choices via remote. For example, a truck advertisement may offer the option of extending the advertisement by showing the engine or passenger compartment features, or may even allow a viewer to request printed material. The instructions for accomplishing an interactive advertisement may be placed in the header material accompanying each advertisement. When an advertisement is selected for playing at an insertion point, the header codes stored at the start of the advertisement will provide the instructions for the box processor to allow interactivity by responding to remote inputs at various places in the advertisement. Events, such as purchasing products, requests for information, signing up for free trials of a product, or entry into contests, may be accomplished over the back channel when the next connection is made. The instruction set for programming interactive advertisements may be similar to HTML code or may be an instruction set that is unique to the system operator. The system and method for providing interactivity and the manner of placing orders for products, product information, or the like, may be carried out in accordance with the teachings of commonly assigned co-pending U.S. patent application Ser. No. 09/645,086, filed Aug. 12, 2000 (Reference number WT-3-CIP3), and U.S. patent application Ser. No. 09/976,836, filed Oct. 24, 2001 (Reference number WT-3-CIP4), which are hereby incorporated by reference in their entireties.

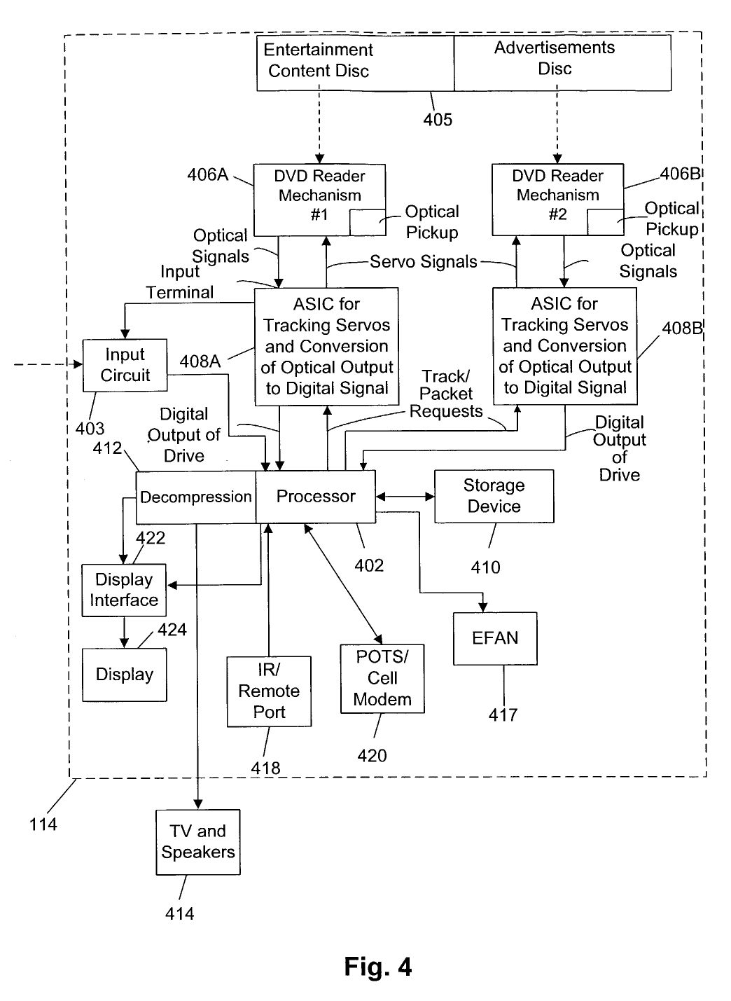

Consistent with the present invention, set top box 114 may contain read ahead capabilities for providing seamless transition between the content disc and the advertisement or index disc. The read ahead capability will allow set top box 114 to store information in a storage device (discussed in FIG. 4) and temporarily play the stored information while the transition is made from the content disc to the advertisement disc in a single reader/multiple disc system. Therefore, the displayed content and advertisement information will seem continuous and seamless to the consumer.

Using the interactivity technology discussed above, embodiments consistent with principles of the present invention may provide lessons to engage, teach, and test via video based content on the content disc, and compare results to near real-time national statistics from the advertisement/index disc. Surveys, contests, and games may also be provided with consumer rewards (e.g., points added to frequent buyer/loyalty programs). Payment for provided lessons may be charged to consumers using the payment method herein disclosed for the payment of other distributed entertainment content.

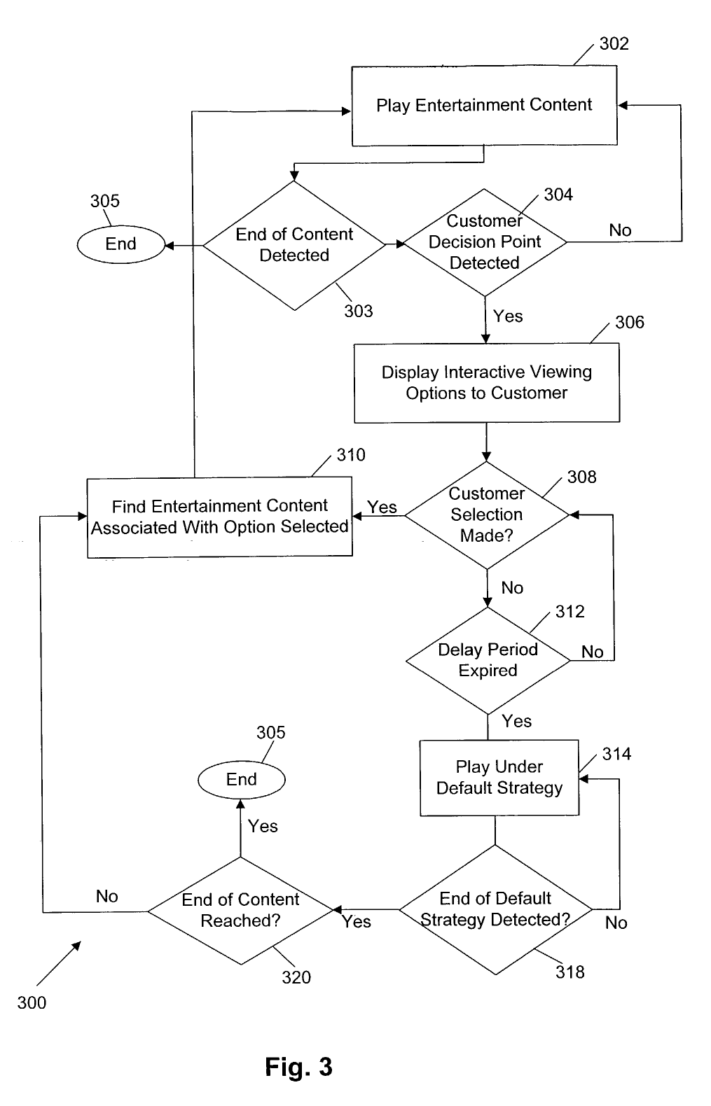

Another use of the interactive technology discussed above is illustrated in FIG. 3. FIG. 3 shows an exemplary method 300 for chaining and programming video segments and allowing the consumer to determine the playback order based on consumer interaction. As set top box 114 plays entertainment content (Stage 302) and it is presented to the viewer, a determination is made as to whether the end of the entertainment content has been reached (Stage 303). If the end of the entertainment content has been reached, method 300 ends (305). Otherwise, method 300 proceeds to Stage 304 and determines if a customer decision point has been detected. A decision point may be a set of bytes in the content representative of a command to request consumer interaction. Consistent with the invention, the command may comprise a pointer to the second reader mechanism containing the advertisements/index disc.

If a consumer decision point is not encountered, set top box 114 may continue to play the entertainment content (Stage 302). If, however, a consumer decision point is encountered, set top box 114 may display interactive options to the consumer through an on-screen display (Stage 306). The consumer may be provided the option to interactively make a selection from the options provided (Stage 308).

If the consumer makes a selection from the options provided, set top box 114 may find the content associated with the option selected (Stage 310) and play the entertainment content. If the consumer has made no selection and the delay period has not expired, the method returns to Stage 308 and waits for the consumer's selection. If, however, the consumer makes no selection and a predetermined delay period has expired, the entertainment content may continue to play under a default strategy (Stage 314).

While set top box 114 plays under the default strategy, a determination is made as to whether the end of the default strategy had been detected (Stage 318). If the end of the default strategy has not been detected, set top box 114 continues to play under the default strategy. If, however, the end of the default strategy has been detected, method 300 proceeds to Stage 320 and determines if the end of the entertainment content has been reached.

If the end of entertainment has been reached method 300 ends (Stage 305). Otherwise, if the end of the entertainment content has not been reached, method 300 proceeds to Stage 306 and displays the interactive viewing options to the customer to continue to play the entertainment content.

Consistent with the present invention, the distribution model for distributing advertisements allows advertisers the flexibility to tailor advertisements more efficiently to specific target audiences. For example, set top box 114 may be programmed to maintain residential preference information for a household, and to present advertisements that are targeted to the preferences of that residence. In particular, set top box 114 may contain a circuit device, which generates consumer preference information containing characteristics of a device user. Set top box 114 may be programmed to select advertisements for presentation on such criteria as the content currently being viewed (romantic comedy, or war movie), historical preferences of content, time of day, location of the box (including zip code or telephone area code), weather, time of year, or demographics of the region. In certain applications, the consumer may be permitted to totally avoid the advertisements by paying an increased fee. In the alternative, a consumer could receive content for a reduced or no fee if they are willing to view additional advertisements. The means for generating and using preference information may utilize the systems and methods set forth in commonly assigned co-pending U.S. patent application Ser. No. 09/502,069, filed Feb. 10, 2000, which is hereby incorporated by reference herein in its entirety.

Consistent with the present invention, the distributed content may be encrypted by hardware, software, or both. Encrypting the content, such that it may not be accessible to the consumer, will allow system operator 106 to control access to the content. For example, hardware encryption, such as can be achieved by optically altering the discs (discussed below), will prevent the discs from being readable by technology currently accessible to consumers. In addition, software encryption will provide further control on access to the content, such that if hardware encryption is somehow broken, viewing the content will still require the user to break the software controls. Such software encryption can use any known or later developed method. Preferably, such a scheme would utilize time sensitive keys that “expire” after a predetermined amount of time.

For additional software protection, all or part of the software control information may be provided with stored check sum information. Methods such as CRC (cyclic redundancy check) may be applied to the software and control information to detect if it has been modified.

An example of a key scheme that may be used is one incorporating three separate, yet dependent keys. For example, a host associated with the content provider can generate a random number (Key A) and transmit it to the consumer's set top box. In addition, the content provider may, through the same or a different schedule, transmit an algorithm, randomly selected from a large number of algorithms (e.g., 3000) to consumer's set top box 114. Another key, Key B may reside in the box, for example, in a circuit device. A circuit device within the box may perform the transmitted algorithm on received key A and stored key B. The result may be a third key, Key C. Key C will then be transmitted back to the content provider for comparison to a key stored at the content provider. If the keys match, an enable signal may be sent to set top box 114 to allow the viewing of the content. In certain applications, it may also be desirable to place a security code on the disc itself. For example, the first words stored on the disc may contain a security code which is over-sampled a predetermined number of times.

The following are further examples of key delivery schemes that may be used when set top box 114 requests authorization to unlock a movie, album, or other digital encrypted content. Once system operator 106 recognizes the request, it generates a key or license while it processes the request to be used by set top box 114 to decrypt the content. To provide the most secure mechanism for key delivery and storage at set top box 114, system operator 106 may implement any or all of the following key or license protection mechanisms:

i) Encrypt the session between system operator 106 and set top box 114.

ii) Use the set top box ID to encrypt the key prior to delivery.

iii) Use the set top box ID that may be a ‘secret’ ID known only to set top box 114 and system operator 106. For example, when set top box 114 logs into system operator 106, set top box 114 uses a login identity of set top box serial number 1000 (a unique ‘known’ serial number). Both set top box 114 and system operator 106 mutually know that set top box serial number 1000 uses a unique ‘secret’ ID of 1XBCE2F. The ‘secret’ set top box ID is never transmitted between the two systems. Further, the ‘secret’ set top box ID is the information used to encrypt the key making the key only usable by the set top box requesting the key.

iv) Use the authentication time from set top box 114 as another parameter in encryption of the key prior to delivery. This simple procedure prevents someone from recording the transmission between set top box 114 and system operator 106 and then replaying the transmission to request a key.

v) Use random and secret information generated by set top box 114 and sent to system operator 106.

vi) Generate random information with set top box 114 that is included in the login to system operator 106. This information is also used as part of an encryption of the key prior to delivery. The introduction of randomness provides the ultimate protection from a potential hacker guessing the information used to encrypt the key. It will be appreciated that this approach works best when combined with the use of an encrypted session between set top box 114 and system operator 106.

In addition to the above security measures, biometric security features, such as face recognition or thumb and/or finger print technology, may also be used for controlling access to the content and/or for storing preference information associated with a particular consumer. It can be appreciated that face recognition and biometric thumb and/or finger print technology may be implemented within system 100 through biometric security device 113.

Consistent with the invention, a user who has received content encoded with a software key or keys may request to view certain content. Upon receiving the request, the box may transmit billing information to the central controller. The central controller may then charge the consumer's account on a rental, purchase, subscription or other basis, and transmit back an enabling command, allowing set top box 114 to decode and present the requested content.

This distribution scheme also maximizes benefit to the advertisers by providing greater distribution flexibility for advertisers. By selecting the advertisements based on a consumer preference, advertisers may analyze the variants to compare sell through for a product in various locations. If any variant in the consumer preference proves to be statistically significant in predicting which consumers will purchase the products, using the variant information, advertisements may be easily modified to better target the audience. This can be done by a feedback loop, which provides data to the system operator or content provider regarding the consumer preferences and the times the advertisement was presented.

In addition, the system operator will be able to charge advertisers directly for advertising. They may charge the advertiser using numerous schemes such as by auctioning advertising time to advertisers based on consumer preferences, or by charging the advertisers according to a rate card (e.g., charging a flat rate for each time the ad is presented to a consumer). In addition, demand for advertising within a particular consumer preference or demographic area can be used to determine advertising rates.

Requiring the system operator to verify the key prior to sending an enabling command also allows the system operator to bill the consumer for the content demanded. In this way, the enabling key may only be transmitted to a consumer who is in good standing with his or her bill. The consumer may be billed on a subscription model (e.g., billed a flat rate for a period of time), a show viewing model, may purchase a show (for unlimited viewings or for viewing for a number of days), or any other desired billing scheme. When billing by the number of presentations of an advertisement, the content provider will have the flexibility to bill an advertiser at discounted rates for a large volume of presentations.

In addition to the above-mentioned billing schemes, an advertiser or consumer may be billed based on a “pay when you played” scheme. Based on this payment scheme, the advertiser or consumer may be billed once or more times per month for the content and advertisements played. As a consequence of this billing scheme, the amount of billing traffic between set top box 114 and system operator 106 may be reduced.

The keys and billing information may be sent via any communication means such as a modem, internet connection, POTS telephone line, cellular telephone, cable backchannel, or other means, including, when available, direct broadcast satellite (DBS) backchannel. In addition, in one embodiment, set top box 114 may contain a credit card or smart card reader for the recording and transmission of payment information.

In addition, the content provider may bill a consumer a higher amount for a subscription to view the audio/visual content without advertisements.

Apparatus consistent with the present invention provides hardware security for the distributed content. The distributed discs may be optically altered DVD's or CD's, (DVDO™). A DVDO is an optically-altered physical medium, which is not readable by currently available consumer players, such as PCs, CD players and DVD players. Examples of such a disc is described in more detail in the above-referenced provisional applications. Consistent with the present invention, an Optically Altered DVD (DVDO™ or DVDOA™) provides content protection in lieu of or in addition to other DRM schemes.

For example, one or more intrinsic optical changes may be made to traditional CD (780 nm) and/or DVD (650/635 nm) disc technologies to render the reading of DVDO or optically altered CD (CDO™ or CDOA™ herein referred to as DVDO) impossible by commercially available readers. Thus for videos, music, and other content, provided via physically delivered media, a DVDO player is required.

A disc is generally composed of at least two layers, a transmissive outer layer covering a reflective inner data layer. Discs are pressed in this format during the manufacturing process. A typical disc is 1.2 millimeters thick. Currently, the outer transmissive layer on a CD is 1.2 millimeters thick. In addition, for a typical DVD, the transmissive layer is 0.6 millimeters thick, such that the reflective data layer is located in the center of the disc, approximately 0.6 millimeters from either surface. Details of conventional DVD discs are set forth in the DVD-Video Format Book Specification, Version 1.11 published in March 1999 by Toshiba Corporation on behalf of the DVD Forum.

In order to read either CD's or DVD's, an optical reader directs a laser through the transmissive layer, focused on the reflective data layer. Modern technology requires the ability to focus the laser at precisely the depth of the reflective layer, in order to reduce bit error rates.

Consistent with the present invention, a disc is provided in which the inner reflective data layer is closer to the surface of the disc. For example, the transmissive outer layer of the disc may be reduced in thickness from 1.2 mm (for a CD), and from 0.6 mm (for a DVD) to a lesser thickness such that conventional readers are incapable of focusing on the reflective layer. By reducing the thickness of the transmissive layer, the reflective data layer of the disc is brought closer to the optical reader. Especially if used in a reader or player with short wavelength laser diodes, this allows for additional data to be encoded on a single disc, which together with improved error correction schemes can greatly increase the storage capacity of discs. When used in combination with a larger buffer, the duty cycle, i.e. the time at which the diode is emitting the laser, may therefore be significantly reduced, therefore increasing the usable lifetime of the diode.

In order to read discs of this type, an optical reader will require a laser diode, which can focus on the reflective surface of the disc through a transmissive layer of less than 0.6 mm. To do this, the reader may include a Z-directional focus mechanism such as a drive mechanism capable of moving the disc tray closer to the laser diode or vice versa. In addition, the reader may simply place a laser diode closer to the surface of the disc than a conventional disc reader.

The DVDO may contain a thin coating of material having a high transmissivity at 400-410 nm and low transmissivity at 635-650 nm allowing the proprietary player to drive a 635 lasers at a higher power to penetrate, but preventing commercially available DVD players from reading the disc. Using the higher transmissivity, thinner coatings, a lower power diode may be used to extend the usable life of the diode.

Instead of, or in addition to, reducing the thickness of the transmissive layer, the optical disc may instead be made thicker than conventional discs. This will also change the focal point at which the laser diode must focus to a point outside of the capabilities of conventional DVDs or CDs.

Finally, discs may provide a hardware security feature by incorporating a larger diameter than a conventional CD or DVD. Such a disc must be sufficiently large that they cannot be inserted and played in a conventional CD/DVD. Such player discs may range from about 125 mm to 300 mm.

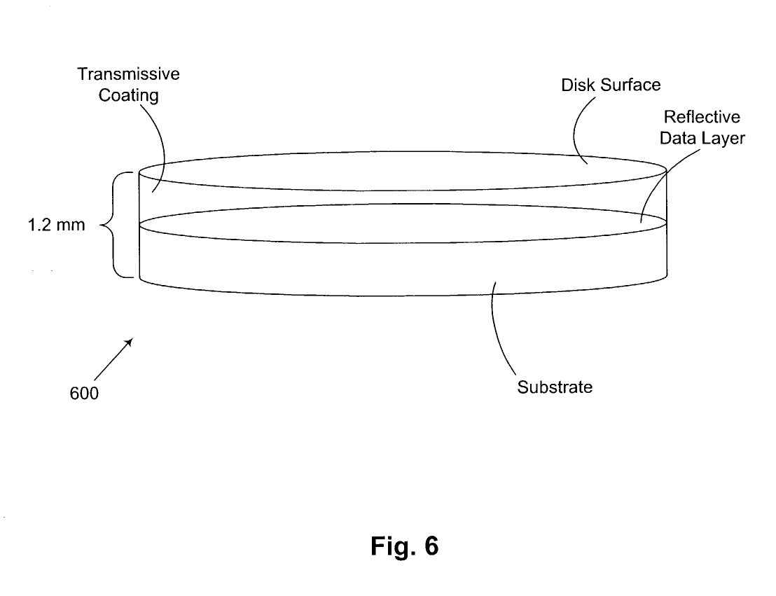

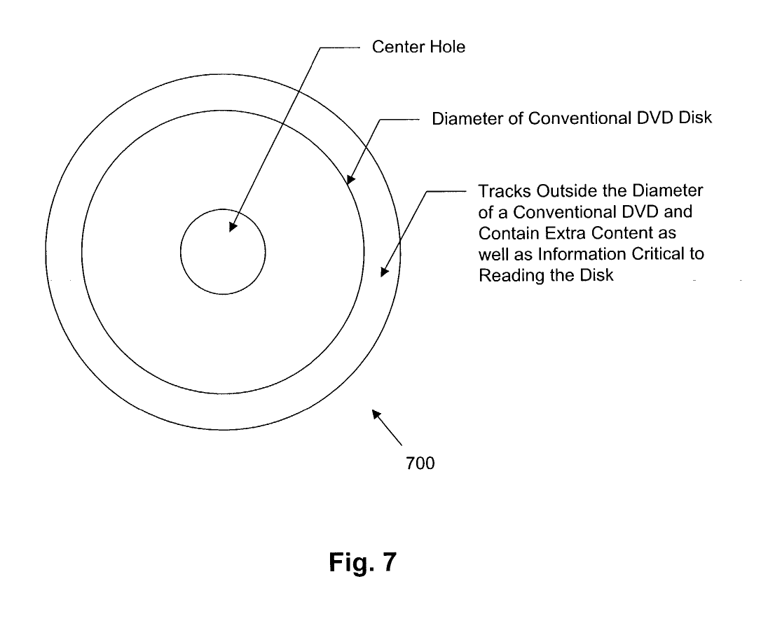

FIG. 6 shows a physical schematic of an optically altered (OA) disk 600. The OA disk cannot be successfully read by a normal DVD player or DVD computer drive because the OA disk is larger in diameter than will fit in the drives or its outer tracks cannot be radially reached by the drive. Typically, information critical to the content or reading of the content is placed on the outer tracks to prevent successful reading of the disk if the disk is physically reduced in diameter. In addition to physical dimensions, disks may be optically modified so they cannot be read by conventional optics and may have error correction or blocking schemes that confound a conventional reader.

In addition, a disc may be altered to include two reflective surfaces. The first may consist of a reflective layer for encoding content in a format consistent with and readable by conventional CD or DVD reader standards. The second side of the disc may comprise a reflective layer for encoding content in a format consistent with and readable by the proprietary optical readers consistent with a DVDO. This would allow distribution agents to distribute unencoded content for viewing by all consumers, while simultaneously distributing content which is unviewable without the proprietary reader.

As discussed above, although certain embodiments of the invention use a 635 nM laser to read the disc, and the disc may contain a dye or a preferential pit depth or other method to prevent future optical readers from reading the track and/or symbol spacings that are closer than conventional DVD readers are designed for; future generations of readers may use 405 nM or shorter wavelength laser diodes to read more densely packed tracks and symbols. Furthermore, because the cost of producing content discs is so low, consumers using second-generation short-wavelength technology may be provided both new content on higher capacity discs as well as replacement of their older discs that may not be readable on these new readers. Furthermore, other techniques, currently unknown, may allow higher capacity or improved encoding or encryption techniques to be used in this business system.

FIG. 4 shows a block diagram of components in one representative set top box 114 consistent with the invention. Set top box 114 includes a processor 402, a first disc reader mechanism 406A, a second disc reader mechanism 406B, a multi-disc tray 405, integrated circuits 408A and 408B, a storage device 410 (e.g., fast memory, hard disk, or optical drive), a decompressor 412, and an output 414. In addition, the system may include a remote unit port 418, a communication interface 420, a video interface 422, and a video display 424. Consistent with the present invention, integrated circuits 408A, 408B, which may be implemented as ASIC's, may perform one or more of the functions listed above. The processor may perform the functions of any circuit devices described. It will be appreciated that the principal components of set top box 114 may be incorporated into the body of a conventional television or other display device.

As shown in FIG. 4, storage device 410 may be DRAM or SRAM to allow block reading or manipulation of blocks of raw data. Modem 420 may be used for back channel communication to obtain keys and accomplish billing, and proprietary ASIC (application specific integrated circuit) may be used as controller/reader for the altered disc. Human interaction may be accomplished via a conventional television remote for box input and characters (or voices) to the television for output to the consumer.

In the preferred embodiment, the functions of the ASIC's may be achieved by other suitable means well known in the art, for example, by digital signal processing (DSP) technology. By using DSP technology, set top box 114 is provided with upgrade capabilities, which will allow the accommodation of new CODEC technologies. For example, the DSP may be upgraded from MPEG-2 to MPEG-4 video compression technology.

An entertainment content disc, such as a DVD, CD, or optically altered CD or DVD (hereinafter a DVDOA) is inserted into first disc reader mechanism 406A, which reads data from the content disc. In one embodiment, the disc contains the audiovisual content provided by a content provider. As the data is read by disc reader mechanism 406A, integrated circuit 408A converts the optical output of disc reader 406A to digital signals. This is then output to processor 402 and may be stored in storage device 410. Alternatively, the output may be sent to decompressor 412 for decompression into output signals to be sent to television (TV) and speakers 414. Note that decompressed signals may also be sent to television (TV) and speakers 414.

In a similar fashion, the then-current advertisements/index disc is inserted into second disc reader mechanism 406B, which reads data from the advertisement disc, and integrated circuit 408B converts the optical signals to digital signals. It will be appreciated that the content disc and advertisement disc may be read by a single optical pickup in a carousel or disc changer apparatus or other similar apparatus wherein the content disc (first medium) and the advertisement disc (second medium) are mechanically, sequentially moved for reading. In this instance, content may need to be buffered for a short period of time to achieve a seamless transition between entertainment content and advertisements.

Modem 420 may be used as a back channel connection to the content provider such as for communicating a play request to the content provider, or for receiving billing information. In addition, modem 420 may be used to communicate billing information, to receive A codes, algorithms or enabling commands for security purposes. Finally, modem 420 may be used to communicate consumer preference information between set top box 114 and content provider 102.

Many consumers may not have a phone jack near their television or may prefer to frequently move their player box to different locations in their home so that a wireless back channel link is preferred. A two-way wireless link may be accomplished using the same or similar technology used for conventional 49 megahertz, 900 megahertz or 2.4 gigahertz “cordless” phones. For example, a 900 MHz link would have a transmitter/receiver/antenna on the box as well as a transmitter/receiver/antenna connected to a phone jack. This system may encode and decode the signals according to conventional analog modem technology so that the wireless link would communicate via an essentially analog signal. As wireless technology advances, the wireless link may be digital with a direct digital connection to a DSL phone or internet port.

Although the embodiment of set top box 114 shown in FIG. 1 has a wired or wireless connection to a normal (POTS) telephone line, in some situations of limited phone access a cellular back-channel link may be desirable. The two-way cellular communication may be accomplished through analog means using conventional modem technology, or via a direct digital communication as is the technology in newer cellular phones. A cellular back channel link will be particularly useful for portable players where the opportunity or desirability of connecting to a POTS line is low, or in countries or regions where cellular phones are more common than POTS telephones.

Set top box 114 may include a display 424 and a display interface 422 for displaying advertising information. The advertising information may be fed from decompressor 412, through display interface 422, to display 424. The advertising information displayed may provide highlight promotions of the content available from the one or more content providers 102. The advertising information on display 424 may be provided to the consumer without energizing television (TV) and speaker 414 and may originate from the entertainment and/or the advertisement content disc, the back channel provided through POTS/Cell Modem 420, or through broadband communications.

Display 424 may be a LCD, segment, or any other type of display device, which is capable of displaying electronic data. Display of the advertising information may be prompted through the insertion of the entertainment content or advertisement disc or an event that occurs during content playback. Additionally, display 424 may be remote from set top box 114 and receive the advertising information to be displayed via display interface 422, using any number of communication paths (e.g., wireless or infrared communications).

In an embodiment of the present invention where display 424 is an LCD display, the advertisement information may be scrolled on display 424 without television (TV) and speaker 414 being energized. The advertising information provided on display 424 may be supplied through the back channel, broadband communications, or other communications means.

Set top box 114 may also include an input circuit 403 for receiving a permission signal originating in the disc inserted into the drive 406A. Alternatively, the signal may originate in the disc inserted into drive 406B or from an outside source, such as a broadcast signal. Circuit 403 generates an enable signal, enabling a circuit device to process the data read by the optical pickup assembly into display signals. The functions of input circuit 403 may be incorporated into processor 402. Some or all of the functions of the circuit device may be incorporated in processor 402 or integrated circuit 408A/408B.

Set top box 114 may further contain a terminal 117 for Emergency Feedback and Notification System (EFAN) compatibility. EFAN is described in commonly assigned U.S. patent application Ser. No. 09/990,450, entitled “System and Method for Emergency Notification Content Delivery,” filed Nov. 21, 2001 (Reference number WT-26), the contents of which are hereby incorporated herein by reference.

For tracking and managing of in-home library content and shipments, set top box 114 may maintain an inventory of all discs shipped to a household and maintain a list of which titles have been purchased for unlimited viewing and which have been rented for a predetermined number of days. The inventory is maintained by storing the identification codes of the shipped discs in persistent storage (e.g., storage device 410). System operator 106 may also maintain an inventory of the discs shipped to consumer homes. For consumer convenience in further managing the in-home library, an interactive television interface (not shown) associated with television (TV) and speakers 414 may be provided to manage the disc inventory (e.g., add, remove, and replace discs).

If the consumer inserts a disc not stored in the in-home library, set top box 114 recognizes that the disc is not in the ‘library’ and adds the disc to the library in non-volatile storage, based on the consumer's confirmation that the disc should be added to the library. Discs that are part of a package may be added to the in-home library as a group with all library information of the package on a single disc, so the viewer does not have to insert each disc of the package to update the library. Discs that are part of a package may be known to processor 402 (e.g. via package information on the advertisement disc) and system operator 106. Since distribution channels have different package numbers, system operator 106 may credit content provider 102 with the use of discs distributed through the specific distribution channel associated with provider 102.

Set top box 114 may also maintain in storage device 410, or other static memory, an encrypted proprietary license to provide access to any particular movie title or entire content disc. Initially, the consumer's request for the viewing content may be sent, through the back channel (e.g., POTS/Cell Modem 420 or through broadband communications), with a set top box's identification and a time stamp to system operator 106.

As a response to the request, system operator 106 may provide an authorizing license for a particular title or disc as a function of the set top box's identification, the time stamp, a key, and a possible random number generator to produce a unique license that is time stamped and transmitted to set top box 114. In set top box 114, the license is encrypted and stored in storage device 410 or other static ram or protected memory, and provides the consumer with access to the particular movie title or content disc.

Set top box 114 may provide software to enable/disable backward compatibility features such as conventional CD-audio and DVD-video. Software running in set top box 114 may detect whether or not all pre-requisite conditions exist for the features to be enabled or disabled. These features may be enabled by adding software patches and/or adding additional hardware to set top box 114, or by providing software on the monthly advertisement/index disc that may be activated by system operator 106. The backward compatibility features may be disabled by deactivating or removing software and/or hardware from set top box 114.

In one embodiment consistent with the principles of the present invention, the software to enable the desired functions may be provided on a control disc for insertion into drive 406A or 406B. Software drivers (CD-audio / DVD-video) may also exist in storage device 410 or non-volatile storage (e.g., EEPROM) or may also be loaded from a control disc.

In addition to the above, set top box 114 may contain an interface for downloading content to a remote (e.g., portable) unit, together with any necessary keys. IR/remote port 418 may be used to securely transfer the necessary keys, and rental and authorization rights, from set top box 114 to remote units. It can be appreciated that other transport methods (e.g., BlueTooth, miniature USB, and X10) and the associated hardware may be used to transfer information between the units. The remote unit may be carried with a consumer away from the home and set top box 114.

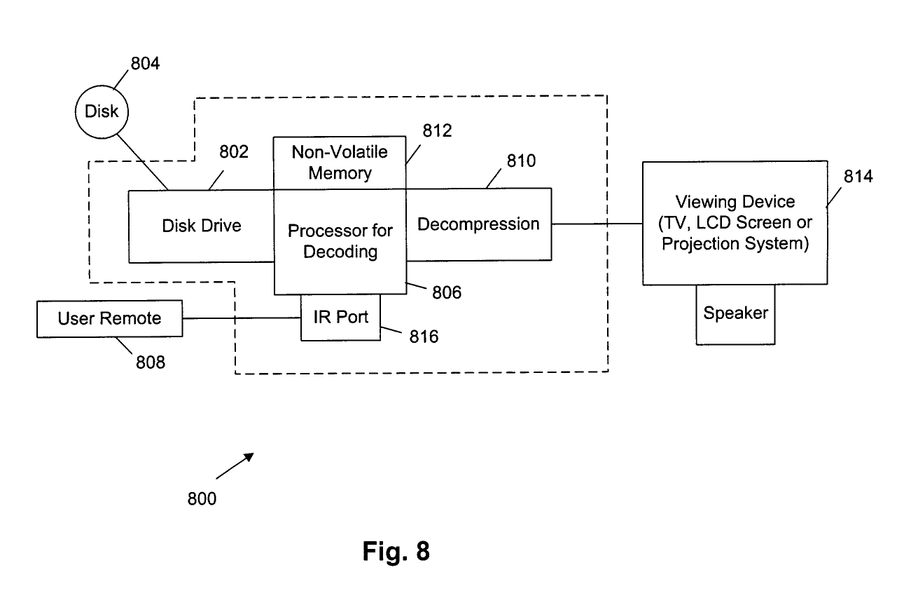

Portable players may take many forms. The simplest player may only play previously purchased music, such purchase information being conveyed to the portable player by the consumer or via a link to his home box or the central computer system (for example via an internet connection). A similar portable player (FIG. 8) may play both music and connect to a television for playing video content. Additional features of the portable player for use with the present invention may be found in U.S. patent application Ser. No. 09/855,992, filed May 15, 2001 (Reference number WT-17-CIP8), the contents of which are hereby incorporated by reference herein.

FIG. 8 shows a simple portable player 800 with drive 802 to read a single disk 804; processor 806 to issue commands to drive 802, issue and track player permissions or credits, receive consumer commands via an IR or wireless remote 808, and conduct decoding and/or decompression 810 of content; and non-volatile memory 812. Multiple content output devices are possible including television sets, small LCD screens, and projection systems 814. Note the IR port 816 may also be used to conduct communication with the home set top box 114 (FIG. 4). Some portable boxes may have a second disk drive for an advertisements disk and/or larger memory capacity to allow caching of advertisements or content.

Portable players may or may not contain the ability to read both content and advertising discs. One embodiment of a portable player may have one drive and require insertion of the ad disc prior to playing a movie so that various advertising or index content is cached in player memory. Portable players may even have sufficiently large memory, perhaps by a small hard drive, so that extensive content may be cached, even including an entire movie. Other forms of advertising on single-disc portable players may involve showing some or all of the advertising from ads that are placed on the content disc. These advertisements may be different (e.g., branding advertisements) from the types of advertisements typically carried on the advertisement discs since they would not change monthly but would exist for the life of the content disc. Consumers may also have the option of renting ad-free content by paying a higher price to play or purchase a movie.

Content may be displayed on different forms of portable boxes by different technologies. Some may connect to a conventional television set allowing a consumer to carry a portable player with them on a vacation where conventional television is available. Another form of the portable box may have a small LCD color screen so that a consumer's children might watch a movie while sitting in the back seat of a car. Another embodiment of a portable box may use a projection technology to allow display of a larger image on a wall or screen. For example, a group of children might watch Bambi at a slumber party by projecting the movie on a bedroom wall. One embodiment of a projection-style portable player may use a solid state light source such as multiple (e.g., eight to ten) white LED's that excite light emitting phosphors to produce video images without the heat of incandescent bulbs and the associated fire or burn hazard. Another embodiment may use digital light processing technology developed by Texas Instruments of Dallas, Tex. (USA).

Back channel communication for extending viewing credit and communicating the content viewed or purchased for proper allocation of movie royalties is desirable for portable players. One method of communication is through having the portable player communicate with set top box 114, and via back channel 105 (FIG. 1) to system operator 106.

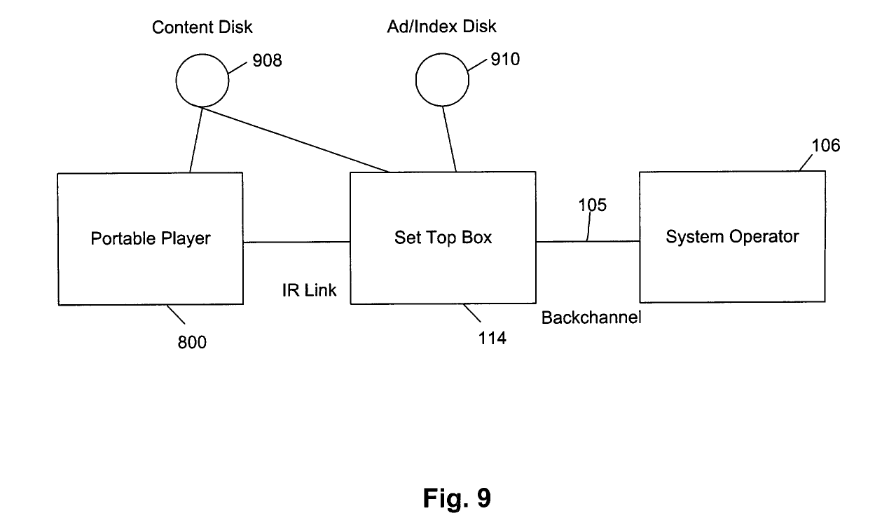

Referring now to FIG. 9, communication between a portable and home player may be conducted via an IR link between the two players using encrypted information and conventional IR communication standards. The IR ports used for this communication could also be the receivers for use with the consumer's remote. Credit or information sent to a portable box may be stored in non-volatile memory such as flash RAM. The same sort of memory may record the identity of the content played for later communication to set top box 114.

FIG. 9 shows one embodiment of the relationship between a portable player 800 and set top box 114. Set top box 114 communicates through back channel 105 with system operator 106 to obtain viewing credits, report movies viewed, and conduct additional communication such as sending decoding keys or taking information requests. Communication of the same information to portable player 800 is done through the IR ports on both set top box 114 and portable player 800. Note that content disks 908 can be played on either set top box 114 or portable player 800, while advertisements disks 910 may not be required for portable player 800. Note that multiple portable players 800 may be associated with each set top box 114.

In another embodiment, portable player 800 may read the index disc. Portable player 800 may read the index disc directly from a reader built into or attached to portable player 800, or through a communications channel to set top box 114.

In normal operation, set top box 114 may be instructed by system operator 106 to extend permission for some time period for portable player 800 to view the content. Such permission may be based upon prior payment history, viewing patterns, or amount of credit extended to the system by a debit or credit card. In addition to viewing permission, set top box 114 may communicate decoding keys, possibly based on the portable player's ID or clock, or parent-set requirements for pin numbers required for viewing some or all material.

Another method of extending viewing permission to portable player 800 is by a physical connection to a home player (set top box 114), such as by a direct wire link, a replaceable chip, or a smart card. In various embodiments, these connections may be established before, during, or after the playing of content according to the methods established by system operator 106. In another embodiment, consumers may be sent a monthly card that communicates viewing permission to portable player 800 as a part of a viewing “club” similar to other club models in which members are sent music recordings monthly upon payment of a club fee. In the club model, use of back channel 105 to extend credit and communicate viewing information may be unnecessary.

For control of set top box 114 and portable player 800, remote control 115 is provided. Remote control 115 provides customary controls for controlling CD and DVD players; however, the eject button may only control the content disc. The ejection of the advertisement/index disc may be controlled through front panel on-screen control 116. Front panel on-screen control 116 may also provide a reminder for the consumer to re-insert the advertisement/index disc, if it has been removed.

Remote control 115 may also include a microphone and the necessary electronics to implement voice navigation for disc control and selection. The voice navigational system may be implemented using voice to l/R translation or other transmissions, such as BlueTooth, for communications between remote control 115 and set top box 114.

Consistent with principles of the invention, the microphone included in remote 115 may be used to personalized video/audio content. Through the use of remote 115 and set top box 114, the consumer may record a person's name or other information and have that audio clip inserted into the movie, scene, or audio content. For example, children's movies may be personalized by recording the child's name and making the child a main character in the movie.

In one embodiment, the microphone may also be used to incorporate live audio into the output of set top box 114 to enable audio integration into the played content (i.e., karaoke functionality).

For both set top box 114 and portable player 800, multiple media play capability may be provided by a single drive that contains both the content and the advertisement discs to allow a smaller and lower-cost system to be built. For example, with a two-disc drive, the two discs may be placed on a single spindle with optical pickups above and below. The inner and/or outer diameters of the two discs may be different to facilitate loading or positioning the two discs on a single spindle. The advertising/index disc may be below with its side to be read facing downward, and the side of the content disc to be played faces upward and is readable by the optics above the discs. The two discs may be both placed on a tray that slides into the reader or placed from the top, one disc at a time. One preferred embodiment, as discussed above, is for the bottom disc (the advertising disc) to be changed only on a monthly basis while the upper disc (content) is changed as new movies (or music) are selected from other discs. Because it is desirable to have distinct visual labels on discs, both the advertising and content discs may be single-side so that the non-read side can carry an easily read label.

Having the two discs back-to-back with a single insertion tray and a single servo for disc rotation can allow portable readers to be smaller and lower cost. Since there is never a need for simultaneous reading the advertising and content discs, a single servo can spin both discs at the same speed. Depending upon desired bit rate and radial position on the disc, the servo may change speed when flipping from one disc to the other. Similarly, it may be desirable to consolidate the two radial servos into a single unit that carries both heads. Again when switching from reading one disc to the other, the radial servo may need to move a significant amount. It may also be desirable to consolidate the electronics to drive the rotational and radial servos as well as the pickup and fine tracking electronics into a single board, again reducing size and cost. Content may be buffered for the few seconds required to change the radial position, change the angular velocity and locate the advertising or content material that the system will play. This short period of buffering may be accomplished by the dynamic memory associated with the box's processor. In some embodiments the two pickups for the two discs may be of different wavelengths to meet cost, protection, or legacy constraints.

In another embodiment according to the present invention, the use a three-tray system may used. In this embodiment, the advertisement or index disc may have two versions. The first version is the “base materials” index disc. This disc may contain all software, graphics, business logic, catalogs, trailers, and other materials required to enable the system to operate. This index disc remains in the receiving tray for months at a time. The disc is only ejected when specifically requested by the consumer. In this embodiment, the system will not function without the “base materials” index disc.

The second version of the index disc is the “updates” disc. This disc contains regular updates to the “base materials” index disc. The index disc updates may be replaced on a regular basis (e.g. monthly) and is only ejected when specifically requested by the consumer. If this updates disc is present, the system will use updated software (e.g., encoding/decoding and DSP control software), graphics, business logic, catalogs, trailers, and other materials from this disc in lieu of the materials on the base materials index disc.

In this embodiment, the trays for both versions of the index disc operate in such a way as to only eject the disc when specifically requested by the consumer. For example, an on-screen function titled “UPDATE PLAYER” will start a process to eject the updates disc and instruct the consumer to insert a new updates disc. Similarly, when an updated base materials disc is received, the consumer will select an on-screen function titled “REPLACE INDEX DISC.” This will eject the updates disc and the base materials disc and then instruct the consumer to insert the new base materials index disc.

Unlike the trays holding the base materials and the updates index disc, the tray holding the entertainment content disc, which may contain encrypted/compressed movies, DVD, or other materials, will eject whenever the normal EJECT button or function is selected.

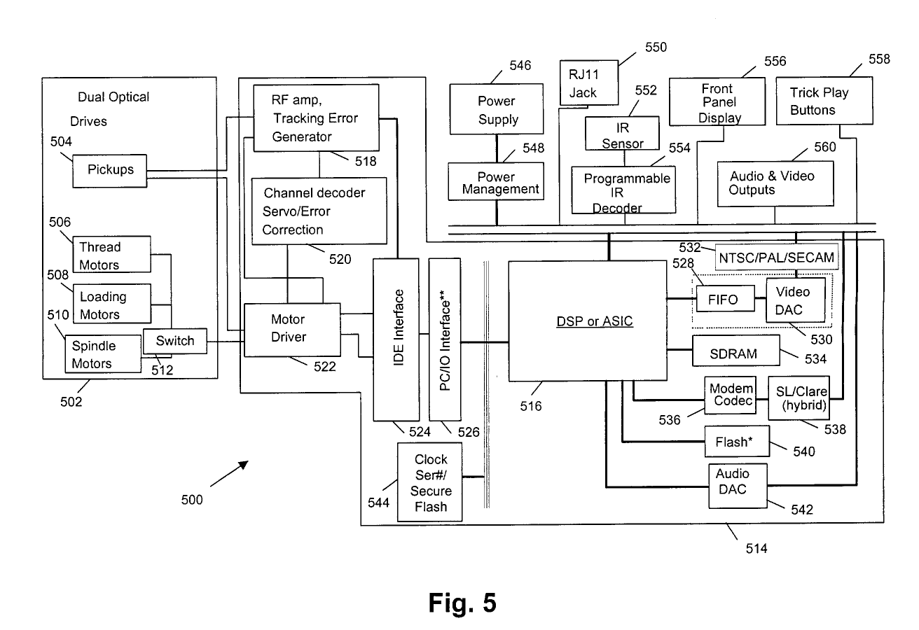

FIG. 5 illustrates a block diagram 500 of a vendor independent design of set top box 114, which may be used to implement the above-described dual drive embodiments. In FIG. 5, a dual optical drives section 502 includes an assembly of components (e.g., pickups 504, thread motors 506, loading motors 508, and spindle motors 510) that make up the physical optical drive. This assembly may include a switch 512, which may be located in the optical drive assembly (as shown) or on a printed circuit board 514.

Switch 512, which may be controlled by the software in the DSP or ASIC 516, may provide spindle motors 502 with the ability to spin in reverse motion to a conventional DVD or CD player thereby allowing discs formatted with a reverse spiral to be read on set top box 114. DSP or ASIC 516 may detect the type of disc that is inserted and may determine whether a clockwise or counterclockwise motion should be used to play the disc.

In the embodiment illustrated in FIG. 5, optical drive components that may be located on printed circuit board 514 are shown separate from the other components on printed circuit board 514 to illustrate that the components of the physical drives may be separated from the components that control the drives and are located on printed circuit board 514. The separation of these components may be used as a security measure to prevent the drive assembly from being removed in one piece from the set top box 114 and being connected to other electronic systems (such as a PC).

Printed circuit board 514 is comprised of components which control the optical drives, process information, and provide the necessary functions for playing video and audio signals. Below is a list of the components that may be included in printed circuit board 514.

i) RF amp, tracking error generator 518, channel decoder servo/error correction 520, and motor driver 522—components that control the optical drives (Motor driver 522 may be directly attached to spindle motors 502 to allow both motors to spin at the same time);

ii) an IDE interface 524—a component that provides the protocol for the digital signal processor to communicate with the optical drive control components;

iii) a PC/IO interface 526—an optional interface component, which some DSPs require while others have the interface integrated;

iv) digital signal processor (DSP) or ASIC 516—processor running software to perform such functions as video decoding (decompressing), DRM processing (determining if the movie rental is in effect, decrypting the movie), menu services (software to display information on the screen, allow a viewer to select options, and to run software executing those options), and modem (software to perform the actual modem operation via the RJ11 jack);

v) FIFO 528—a buffer to feed information to the Video DAC;

vi) Video DAC 530—converts digital video information to an analog video signal;

vii) NTSC/PAL/SECAM 532—from the analog video signal creates a (i) NTSC (National Television Standards Committee) signal compatible for use in the United States; (ii) a PAL (Phase Alternative Line) signal compatible for use throughout Europe and China, as well as various African, South American, and Middle Eastern Countries; and iii) a SECAM (System En Couleur Avec Memoire) signal compatible for use in France and Russia and many countries in Africa, Eastern Europe, and the Middle East.

viii) SDRAM 534—memory to store information required by software running on the DSP;

ix) Modem Codec 536 & SL/Clare 538—provided for DSPs that cannot support modem software in the DSP—a separate component providing the modem function;

x) Flash 540—persistent or non-volatile memory to hold information required by the software running in the DSP;

xi) Audio DAC 542—converts audio digital to analog information; and

xii) Clock Ser#/Secure Flash 544—one or more components to provide a clock function (may be included in the DSP), provides a unique number identifying the player and may include secure flash for non-volatile storage.

In addition to the above, external to printed circuit board 514, the following components may be included in set top box 114: i) Power supply 546—provides external power into the set top box 114; ii) Power management 548—components to regulate power as needed for set top box 114 components; iii) RJ11 jack 550—external interface to connect to a standard telephone link; iv) IR sensor 552—external interface to receive infra-red signals (from an IR remote control); v) Programmable IR decoder 554—converts IR signals to a code understood by the software running in the DSP; vi) front panel display 556—display to provide set top box 114 status, informational messages, etc.; vii) Trick Play buttons 558—(e.g., provide play control functions such as rewind, fast-forward, etc.); viii) Audio & Video Outputs 560—jacks and other external interfaces to audio and video components (e.g., RCA video jack to supply a signal to a television).

Set top box 114 may use one or more of the above-mentioned interfaces for downloading music to a recording device so that a consumer may record purchased music onto a standard medium (e.g., CD) for enjoyment in other players in the home or automobile. The downloading of purchased music for this purpose may be limited to a certain number, for example, one or two downloads.

Improved protection to piracy of video content is available for movies played on set top box 114. Copying of movies played from either conventional VHS or DVD players can be accomplished by recording the video and audio as they are electrically passed from a player to a television set. This form of piracy may be limited by set top box 114 encoding a number unique to the box or account being used by the box in the video or audio signal by techniques known as “watermarking”. The watermarks containing the identity number may be visible or audible to the consumer or may be hidden so that decoding of the electronic signal is required to determine the encoded identity number. With watermarking, direct copying of the video signal is reduced because the identity of the copier can be determined by examination of the illegal copy. Consumer contracts can include a penalty for unauthorized recording and playback of copies. This provides a realistic disincentive to pirates beyond conventional DVD or VHS players. Watermarking techniques that may be used are discussed in commonly assigned co-pending U.S. patent application Ser. No. 09/487,978, filed Jan. 20, 2000, the contents of which are hereby incorporated by reference herein.

Consistent with one aspect of this invention, visible watermarks can be added to video and the like to identify content that has been the subject of unauthorized copying. In one embodiment, the watermark would be noticeable if removed (e.g., by removing or editing one or more video frames).

It will be appreciated that watermarks according to this invention are not necessarily used to enable or disable set top box 114 from reading digital content. Rather, they are primarily used to identify the source of the content. If the content was repeatedly copied, the embedded watermarks could be used to reveal the content's copying history.

As mentioned above, watermarks consistent with this invention can be visible or invisible. Visible watermarks may be added at the beginning and/or end of the entertainment content so as not to interfere with the entertainment content itself. Invisible watermarks, however, may be inserted anywhere in the entertainment content because their presence will not interfere with the viewing experience.

Watermarks may last for any convenient length of time (e.g., a fraction of a second to several seconds, or more). When the watermarks last for more than about 1/30^{th} of a second (i.e., the temporal sensitivity limit of the human eye) the watermarks will be visible. When the watermarks last for less than about 1/30^{th} of a second, the watermarks will be invisible at normal viewing speeds, but will become visible at slower speeds (e.g., frame-by-frame). As explained more fully below, invisible watermarks may be embossed in a random fashion into the output to avoid easy detection.

Watermarks may be added to content at any time before the digital content is output by set top box 114. For example, watermarks may be added to a movie during the encoding (i.e., compression) stage. In an alternative embodiment, watermarks may be added to a movie during the decoding (i.e., decompression) stage. In yet another embodiment, watermarks may be added after either encoding or decoding, but in all cases before the digital content is provided at an output of set top box 114.

For example, watermarks consistent with this invention can be generated by a media content player (e.g., set top box 114), with or without a networked server, during playback. Thus, the watermark may be generated in real time each time a movie is played.

It will be appreciated that watermarks according to this invention may be generated for use with standard or proprietary digital content. In the case of standard formats, a decoder can be used to decompress and form the appropriate video frames before the watermarks are inserted. In the case of a proprietary format, the decoder may be programmed to insert the watermarks into the content during the decoding process. In either case, the watermarks are preferably inserted before the video digital-to-analog converter processes the content.

In one embodiment, the watermark may include information that identifies a particular set top box 114 and an NTSC chipset. NTSC stands for the National Television System Committee and is commonly used to refer to one type of television signal that can be recorded on various tape formats, such as VHS, ¾″ U-matic, and Betacam.

For content provided through rental or pay per view services, such as over a network, a unique transactional identification code, such as a hexadecimal representation, that is associated with that rental event and set top box 114, may be downloaded from a remote commerce server. That unique transactional code may then be used to generate a watermark (i.e., tag) that is embossed on the content to form a watermark.

Examples of electrical and optical networks that can be used to deliver digital content consistent with this invention are described in U.S. patent application Ser. No. 09/416,333, filed Oct. 12, 1999, U.S. patent application Ser. No. 09/315,111, filed May 18, 1999, U.S. patent application No. 09/301,102, filed Apr. 28, 1999, all of which are hereby incorporated by reference in their entireties. It will be appreciated that other types of networks can also be used, such as satellite-based networks, consistent with this invention.

When content is provided through portable media (such as a DVD or DVDO), a player or set top box may be programmed to generate a unique transactional identification code for use in a watermark. The code may include, for example, a set top box identification code and a time stamp. It will be appreciated that any of the generated codes and time stamps may be in any convenient form, including a hexadecimal form.

If the watermark includes a transaction code that includes one or more (e.g., hexadecimal) characters, then one or more of those characters can be altered before being used to optimize the survivability of the watermark upon further compression and/or analog to digital and digital to analog conversion. In one embodiment, certain characters can be altered to improvement the survivability of the most distinguishing characteristics. For example, although “1,” “L,” and “I” are three different marks, their combined use may not be advisable. Accordingly, character “1” can be replaced with character “X.” In another example, hexadecimal code “123456789ABCDEF” contains a number of potentially confusing characters sets: (1) “E” and “F,” (2) “6,” “8,” and “9,” (3) “8” and “3,” and (4) “4” and “A.” Because “4” and “A” may be considered too close, a character substitution protocol can be applied that allows the use of character “A” but replaces character “4” with another less-confusing character, such as “J.”

TABLE 1 shows one possible substitution protocol that can be used consistent with this invention:

TABLE 1

| Original | Substitute |
|---|---|
| Character | Character |
| 1 | H |
| 2 | 2 |
| 3 | 3 |
| 4 | J |
| 5 | 5 |
| 6 | K |
| 7 | 7 |
| 8 | M |
| 9 | P |
| A | A |
| B | U |
| C | C |
| D | D |
| E | E |
| F | X |

Using the protocol shown in TABLE 1, hexadecimal code “123456789ABCDEF” becomes “H23J5K7MPAUCDEX.” Additional characters that might be substituated for increased readability are: %, +, =, >, and #. Also, the “0”(zero) character can be elimenated. It will be appreciated that the protocol shown in TABLE 1 is for illustration only and that many other types of substitution protocols can be used consistent with this invention.

It will be appreciated that a seven character code, where each character can have any of 15 different values, can provide over a trillion unique permutations. Thus, the set top box manufacturer, distributor, and associated service providers could easily identify every deployed set top box 114 with a unique player code.

Consistent with another aspect of this invention, the character code may be scrambled in such a way as to make it difficult to directly tie any set of characters to any particular set top box 114 without knowing the scrambling method. For example, one scrambling method might be dependent upon the value of the first character. If the first character, for example, has a value between 1 and 7 (i.e., after translation), then the remaining characters can be read alternating from the last character to the first character. The remaining characters can then be read from the first character to the last character. It will be appreciated that transaction codes may be scrambled according to any other scrambling method as well.

As mentioned above, a watermark consistent with this invention may be randomly generated as a function of time. The random temporal distribution of watermarks may also prevent easy detection and removal by those wishing to copy the content without authorization.

To facilitate the detection of random watermarks in digital content by an authentication service, for example, the watermarks can be embossed such that adjacent watermarks are distributed with some minimum and/or maximum separation between adjacent watermarks. A minimum separation prevents too many tags from appearing in too short a period of time, which may cause the tags to become visible. A maximum separation allows an authenticating service the ability to search a fixed number of frames to determine whether any tags appear. Such a maximum could ensure that any movie clip longer than a fixed duration would have a watermark if, for example, the clip was recorded from an analog output port of set top box 114 consistent with this invention. For example, watermarks can be separated by a maximum number of frames, time-period, etc. In one embodiment, watermarks could be randomly inserted about once every 30 seconds.

Embossed watermarks can be made more invisible than other non-embossed watermarks. During the embossing procedure, for example, the tag appears to rise from the frame with the same or similar colors as the background colors, rather than with colors that are substantially different from the background colors.

Watermarks can be located anywhere on a frame (e.g., screen). In one embodiment consistent with this invention, watermarks can be randomly positioned on frames to prevent easy detection and removal by those wishing to copy the content without authorization.

Embossing characters is a simple/known arithmetic calculation to edit selected pixels within a range. Real-time embossing may be performed during the decoding process of a movie or programatically added before the film is routed to an output port. Watermarks consistent with this invention may be embossed on any set of content while the content is displayed via an output port including, for example, menus, DVD Video Disk Playback, other video compression playback, etc.

The video tags can provide identification information (e.g., information that can be used to identify the set top box that generated the video output). A unique transaction code can be generated by the server authorizing the rental or purchase of the movie content. In this case, the transaction code need not identify the set top box directly, but the code is associated with the set top box identified in a server database. This allows the information to clearly identify the source of any content copied during playback from a set top box consistent with this invention.

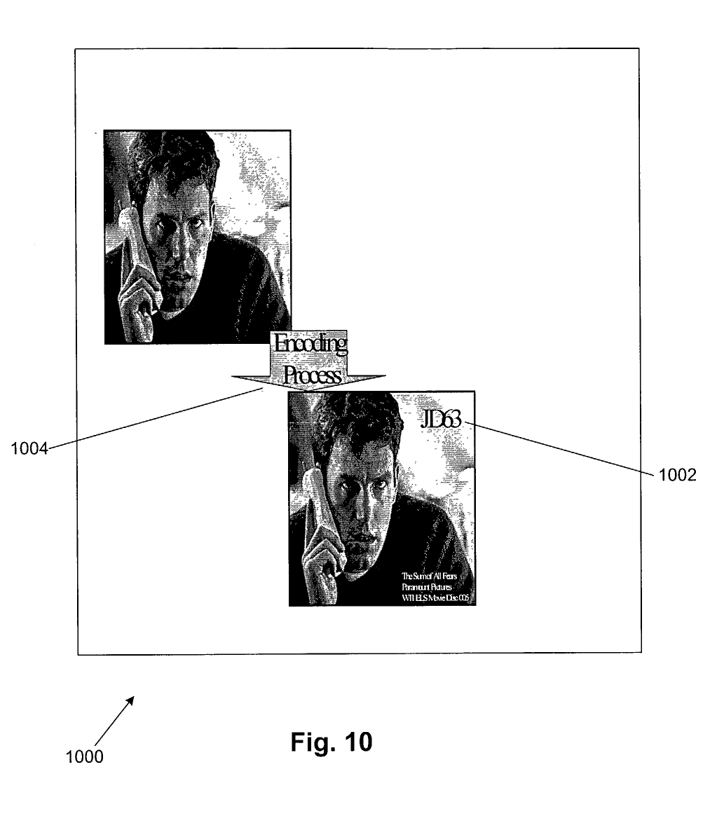

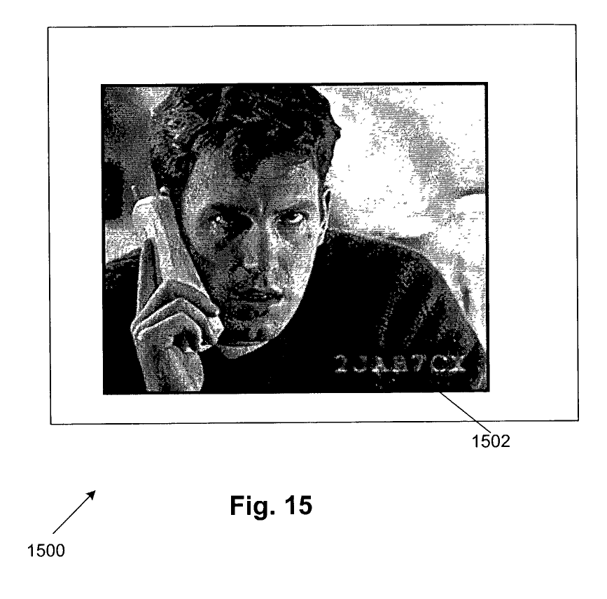

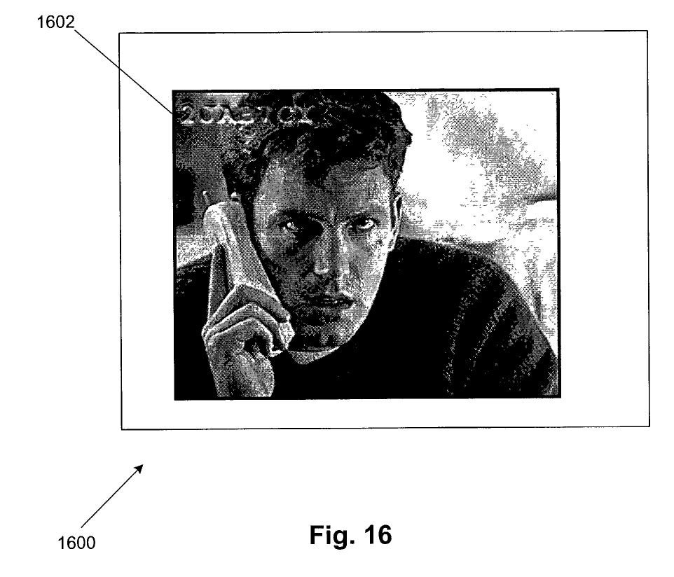

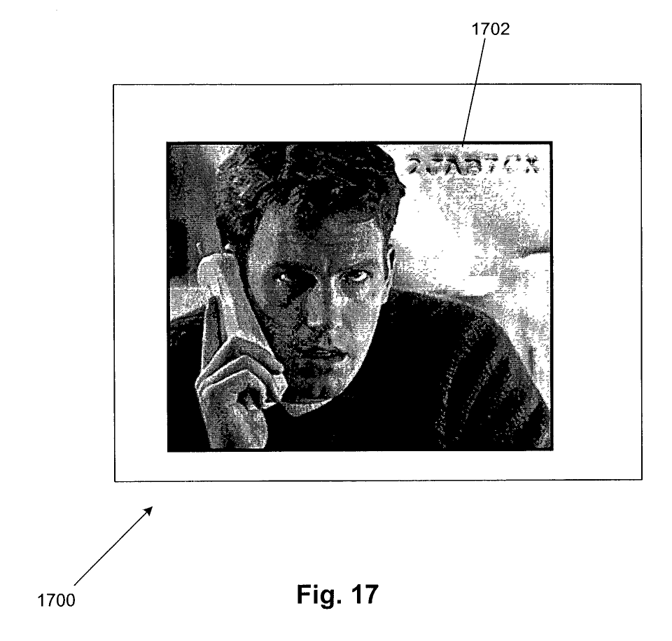

FIGS. 10-17 show a number of video tagging block diagrams that include exemplary video frames that have been tagged consistent with the present invention.

FIG. 10, for example, shows a video tagging block diagram 1000 in which a watermark 1002 is inserted into the video content during an encoding process 1004. The watermark may include identification information and may be located, for example, at the beginning and/or end of a movie. In one embodiment, the information is visible to the viewer.

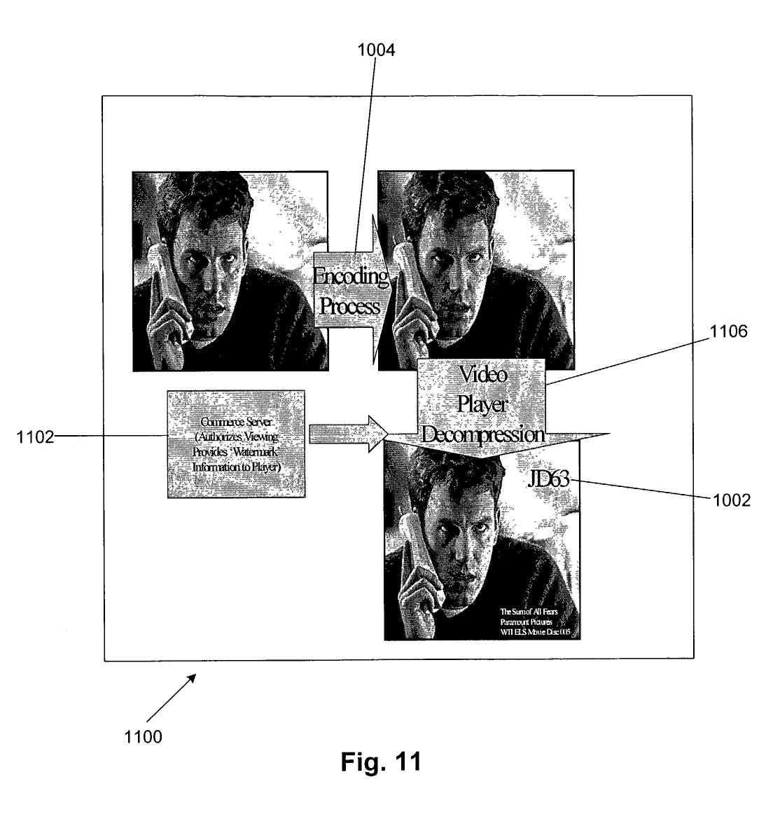

FIG. 11 shows another video tagging block diagram 1100 in which watermark 1002 is inserted into the video content during play-back/out using a video player or set top box and optionally a commerce server 1102 consistent with this invention. Once again, watermark 1002 can include identification information and may be located, for example, at the beginning and/or end of a movie. In one embodiment, the information is visible to the viewer. The method shown in FIG. 11 is different from the method shown in FIG. 10 because no watermark is added during the encoding process 1004. Commerce server 1102 may be used in combination with the player to authorize a viewing and to provide some or all of the watermark information to the player during the video player decompression process 1106. In another embodiment, the player itself can generate some or all of the watermark information.

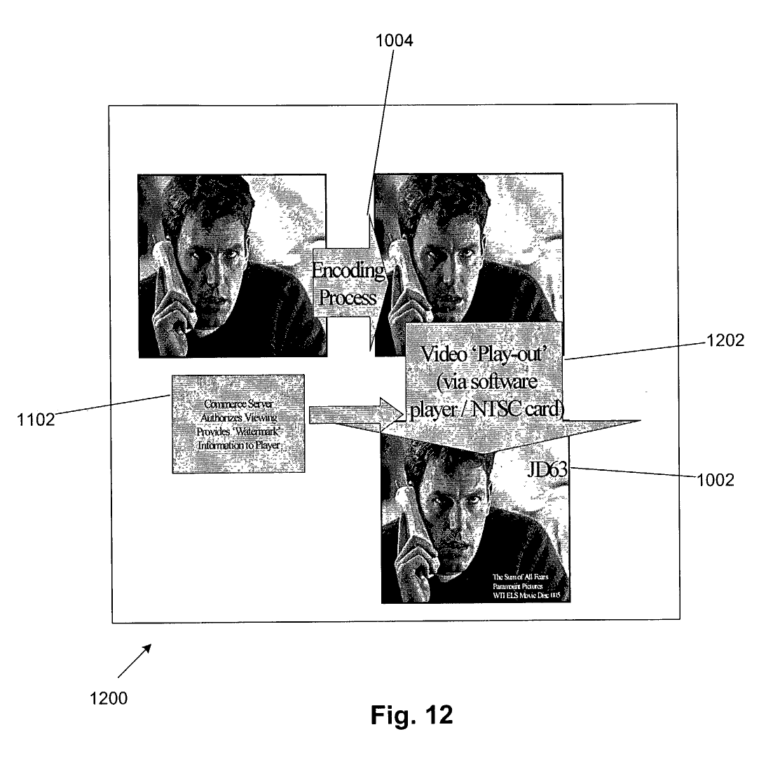

FIG. 12 shows still another video tagging block diagram 1200 in which watermark 1002 is inserted into video content during play-back/out using (1) a video play-out with software player and an NTSC card 1202 and (2) optional commerce server 1102 consistent with this invention. In most other respects, the methods shown in FIG. 11 and 12 are the same.

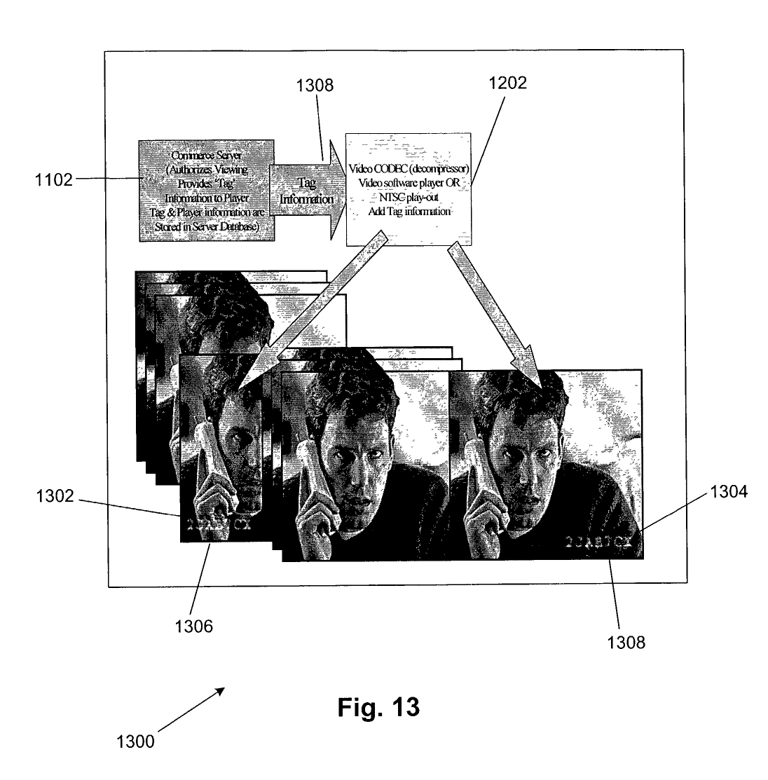

FIG. 13 shows yet another video tagging block diagram 1300 in which a tag is inserted into video content during play-back/out using a player or set top box and optional commerce server 1102 consistent with this invention. When a player is used to insert the tag, a video software player (the video CODEC section) or NTSC card 1202 may provide the tag information during play-out. In this case, identifying information can be added to a single frame (e.g., frames 1306 and 1308) at random intervals with a maximum spread between tags (e.g., no more than five minutes between tags). Tag locations may be randomly chosen to circumvent detection. The tag information in tags 1302 and 1304 shown in frames 1306 and 1308 are the same. It will be appreciated, however, that the tag information may be different for each tagged frame, and may, for example, provide a de-scrambling code.

In one embodiment of the present invention, set top box 114 disables the display of the watermarks during playback/out so that they are not visible to the consumer.

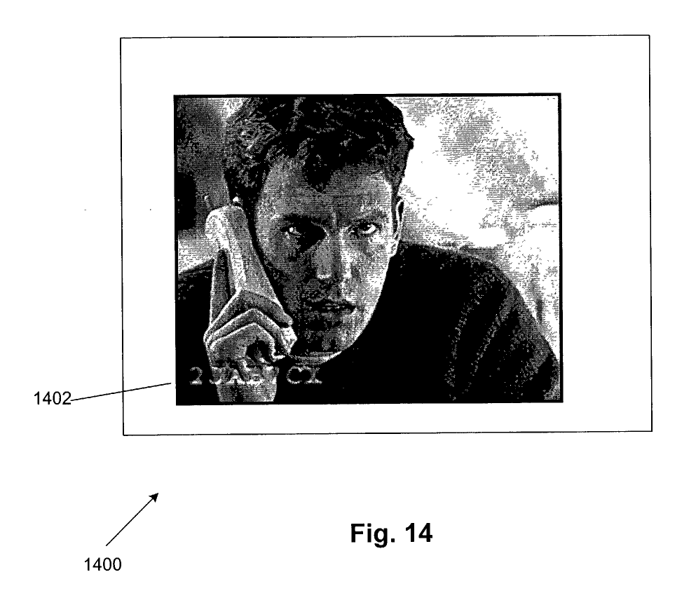

FIGS. 14-17 show a series of video frames (1400, 1500, 1600 and 1700, respectively) with embossed tags (1402, 1502, 1602, and 1702, respectively) that have been inserted into video content consistent with this invention. As shown in these figures, the location of each tag within its respective frame may be different.

In addition to the location of the watermark, to reduce the visibility of the watermark during normal viewing, various methods may be implemented. For example, these methods may include: (1) not placing tags in the interior 60% of the viewing area where the focus of viewing is natural, (2) placing tags in the “safe area ” of the viewing screen that usually falls outside the normal viewing range of many televisions, (3) orienting tags on the left and right margins to reduce perception and use of screen real estate, (4) embossing tags with as little inserted color as possible (e.g., the tags may simply be a modification of the existing color on the screen), (5) not using certain embossed marks due to their background placement (this is possible due to the frequency of their placement throughout the film), (6) placing tags in high action scenes, (7) placing tags immediately before a scene change or key frames to make them less visible, and (8) separating specific characters of a tag on the screen to make the tag less perceptible.

Consistent with the invention, one skilled in the art will appreciate that watermarks according to this invention may also be placed randomly into digital audio content (e.g., a digital audio stream).

Implementation of the present invention may be carried out in large measure using existing infrastructure. More particularly, existing electronics manufacturers may be utilized to manufacture set top boxes 114, as well as the portable players. Set top boxes are proprietary due to their unique features such as DVDOA™ security features, resulting in increased incentive for electronic manufacturers to be involved. Additionally, existing international parcel delivery companies, such as Federal Express, have the capability to deliver the set top boxes and discs to consumers throughout the world. The same companies have established “backroom” infrastructure, communications capabilities and billing expertise to handle many of the communications and/or billing needs of the system. Furthermore, content providers have many incentives, discussed herein, to participate. In addition to making available current and deep catalog movies and music recordings, the content providers will be afforded extraordinary flexibility with respect to new and syndication properties, such as a television series. For example, the new episodes of a television series (e.g., 12 episodes) may be shipped to consumers on a disc with a time-based pricing schedule. The episodes may be made available all at once for, say, $1.50 per episode, while as a consumer alternative, the shows may be made available at $0.75 per episode if the shows are unlocked for viewing on a one show per week basis over twelve weeks—in accordance with the current television broadcast model.

Further to the extraordinary flexibility provided with respect to syndication properties, consistent with the present invention, content providers may also be provided with the capability of providing pre-cached time-controlled entertainment content for viewing. For example, if a movie is scheduled to be released on August 14^{th}, the content provider may ship the time-controlled entertainment content to consumer locations on August 1. At this point, the entertainment content is at the consumer location, but it cannot be played.

During the period of time that the entertainment content cannot be played, the consumer may be provided, using the advertising capabilities of the present invention, advertisements of the upcoming release (e.g., using the LCD display to scroll an advertisement of the upcoming release). Then, at the stroke of midnight on the release date (i.e., August 14^{th}), the entertainment content is made available to the consumer. Thereby, the consumer is provided with the most recent releases without having to rush to the store or rental agencies to obtain them.

As shown in dashed lines in FIG. 1, the output from a consumer's cable television set top box 130 or direct broadcast satellite (DBS) set top box 140 may be routed through set top box 114 to television 118. In this embodiment, set top box 114, through the advertising disc then residing therein, may be used to insert advertisements into cable television or DBS programming by either overriding broadcast advertisements or filling in broadcast spaces left open for advertisement insertion. To this end, cable television box 130 or DBS box 140 streams a signal (typically, an analog signal) with an analog header that directs box 114 to insert an advertisement according to the insertion technique described above in connection with FIG. 2, or other suitable technique. The inserted advertisement may be selected from the available advertisements on the advertisement disc according to consumer preferences. Preferably, information concerning the played advertisements may be stored in memory at box 114 and communicated to the central computer of the system operator when the box is queried. Additionally, as shown in FIG. 1, the output from a consumer's VCR 150 or DVD player 160, or other similar device, may be routed through box 114 for convenience in wiring between the various boxes and the television.

It will be appreciated that the terms “consumer ”, “viewer,” and “user ” are at times used interchangeably herein to refer to those who view and listen to the content. Also, the term “advertisement disc” has been used for convenience to refer to those discs (the second medium) that contain advertisements, with it being understood that the advertisement discs may also contain an index to available and upcoming entertainment content, as well as other information. Finally, the term “entertainment content” has been used for convenience herein to refer to the content on the first medium—the content that is viewed and listened to primarily for entertainment, with the understanding that the content on the first medium may contain other information.

The other information that may be included in the first and second media may include movies, television shows, sporting events, informational content (i.e. travel brochures), how to/instructional content, educational content (such as National standards testing or home schooling), audio content (i.e. music), Karaoke, video games, electronic books, advertising content (such as video catalogues), digital images, and other video, audio, or audio/video content suitable for distribution. The second medium may also

Other embodiments of the invention will be apparent to those skilled in the art from consideration of the specification and practice of the invention disclosed herein. For example, from the disclosure of the embodiments of set top box 114, it can be appreciated that a commercial player consistent with the security (e.g., the content locking keys), entertainment content, and advertising features of the present invention may be developed. This commercial player may be utilized in a high end home or commercial cinema system.

This embodiment of a set top box 114 may contain multi-disc tray 405 (FIG. 4) with multiple disk slots, thereby providing the commercial player with the capability to read multiple discs simultaneously. For example, the commercial player may have the capability to play anywhere from 1 to 10 disks simultaneously. The multiple discs will provide the necessary data to display full length features, which may require approximately 140-150 gigabytes of information for a two hour movie. In addition to providing entertainment content on the multiple discs, one or more index discs may be provided for implementing the advertising capabilities of the present invention.

To display the information on the cinema screen through the projection system 120 (FIG. 1), the commercial player may simultaneously read the multiple discs and feed the information, in the proper order, to a hard drive or optical disk device which then feeds the projection system that displays the entertainment and/or advertisement content. The information from the multiple discs is provided at an adequate data rate (e.g., data rates in excess of 21 megabytes per second) to the projection system.

The commercial player may be implemented using disk stripping on an optical disk or hard drive device. For example, the commercial player may read the first bit from disc one, the second bit from disc two, the third bit from disc three very quickly so that the combined data from the multiple discs is fed into the hard drive or optical disk at a rate faster than projector system 120 requires to display the entertainment content.

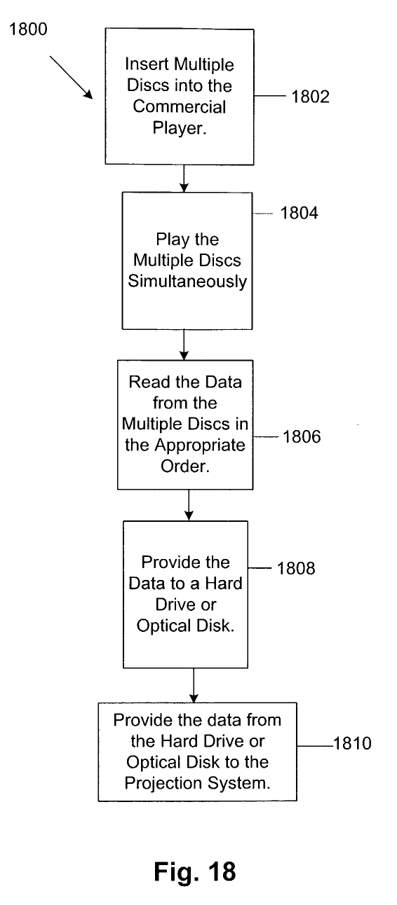

FIG. 18 illustrates an exemplary method of providing the electronic data to projection system 120. In method 1800, once the multiple disks are inserted into the commercial player (Stage 1802), the discs are read simultaneously (Stage 1804) and in the appropriate order (Stage 1806) to provide the electronic data to a hard drive or optical disk (Stage 1808). Then, the electronic data is provided from the hard disk or optical drive to the projection system, which displays the entertainment content on the screen (Stage 1810).

By providing the entertainment content on multiple discs, a security feature is provided, because each of the discs may no longer be a sequential set of data points. Each disk may contains one out of every 4, 5, 6, or 10 bits of information depending on the length of the movie and the amount of resolution that is being delivered. Therefore, stealing one or more of the discs serves no useful purpose, because the entire set of discs is required to display the entertainment content.

The commercial player consistent with the present invention costs less to manufacture than current commercial projection systems. Moreover, the multiple discs provided with the entertainment content may be produced at a fraction of the cost of current commercial movie reels.

In additional to the above, the commercial player may receive media feed streams, which may be inserted into the hard drive format and made available to a projection system. The feed streams may originate from various communication networks including, for example, satellite, cable, OC-3, and optical communications networks. The Internet and intranets may also be used to provide the media feed streams.

The capability to receive media feed streams will allow the commercial player to display live events, such as concerts and boxing events. The media feed streams may be transmitted to commercial players in cinemas and projected onto large screens capable of serving the general public. The media feed streams may be displayed using the systems and methods described in co-pending U.S. patent application Ser. No. 09/385,671, filed Aug. 27, 1999 (Reference number WT-1), U.S. patent application Ser. No. 09/436,281, filed Nov. 8, 1999 (Reference number WT-1-CIP1), U.S. patent application Ser. No. 09/426,078, filed Dec. 30, 1999 (Reference number WT-1-CIP2), U.S. patent application Ser. No. 09/301,102, filed Apr. 28, 1999 (Reference number WT-2), and U.S. patent application Ser. No. 09/416,333, filed Oct. 12, 1999 (Reference number WT-2-CIP2), which are hereby incorporated by reference in their entireties. The media feed streams may also be displayed using the systems and methods described in U.S. Pat. No. 6,424,998.

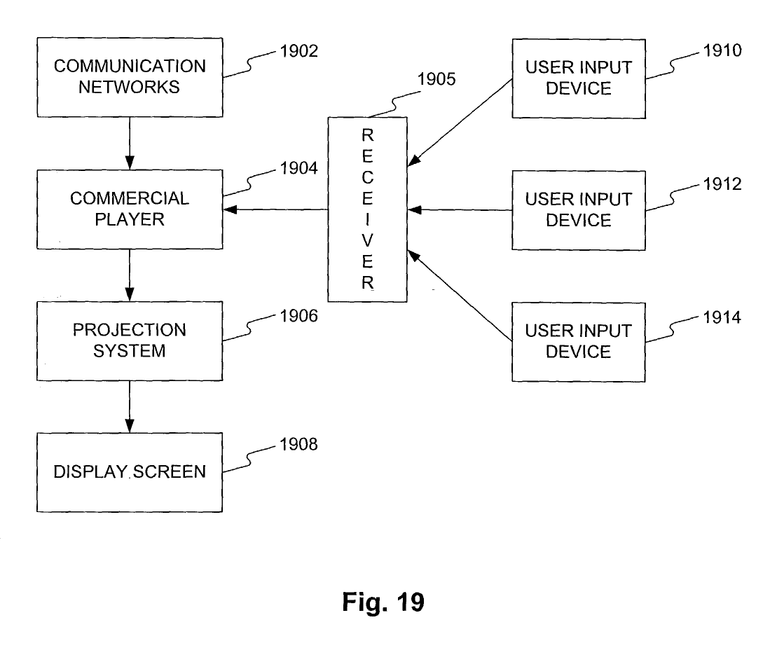

FIG. 19 provides an diagram illustrating of an illustrative embodiment of a media feed system. FIG. 18 shows that commercial player 1904 is provided with media feeds from communications networks 1902. Commercial player 1906 may provided the information to the projection system as describe above (e.g., using disk stripping). The projection system displays the streamed media to the consumer on the display screen 1908. FIG. 19 also shows user input devices 1910, 1912, and 1914, whose functions will be described below.

As described above with respect to set top box 114, commercial player 1904 also has the capability through an index disc to provide advertisements with the media feed stream. The advertisements may be provided before, after, or during the display of the media feed stream. The advertisement may also be displayed through various methods that will be described below.

As one example, advertisements may be selected and inserted into the media feed stream in an interactive way. This method will allow participants in the theater to participate and provide input to select the advertisements that will be displayed. For example, the participants may be provided with a set of predefined questions, quizzes and/or games, which the participant may answer. From the participant responses, a profile of the viewing audience may be determined. The profile identifies the particular likes and dislikes and determine the type of advertising that would appeal to the participants.

The participants may provide their response by using a hand held device or a device installed into a seat, such as user input devices 1910, 1912 and 1914. These input devices may be communicate with a receiver 1905 using a non-visible communication protocol, such as an infrared communications protocol, using high power emitters, or RF communications. Each participant may be identified using a initialization procedure whereby the participant enters his or her name or the participant may be identified using a code transmitted by the input devices (1910, 1912 and 1914).

Another method for identifying the user may include using a cell phone to register with an input device located at the participants seat. The cell phone and input device may use a number of communication protocols to communicate, such as an infrared or an RF communications protocol. Once the user registers, using the POS system described in co-pending U.S. patent application Ser. No. 09/645,086, filed Aug. 12, 2000 (Reference number WT-3-CIP3), and U.S. patent application Ser. No. 09/976,836, filed Oct. 24, 2001 (Reference number WT-3-CIP4), which are hereby incorporated by reference in their entireties, commercial player 1904 identifies the participant.

Then, whenever the participant sees an advertisement during the display of the media feed stream, the participant can request additional information or purchase the advertised item or service and the request will be satisfied and sent to the participant. In addition, since the participant is identified, advertising information may be targeted directly at the participant. For example, the participant may be named or given promotional items during a particular advertisement.

As another method of selecting advertisements, the cinema operator may select a profile based on the participants in attendance. For example, the cinema operator may choose a profile which includes advertisements targeted to youths or watchers of a particular sport.

As yet another method of selecting advertisements, the advertisements may be selected automatically, which may be a function of the demographics of the cinema location and/or stored profiles. The methods for automatically selecting advertisements based on consumer preferences have been described above in relation to set to box 114.

As yet a further method for selecting advertisements, the advertisements are selected by the content provider and the selection information is provided with the content disc(s) or media feed stream. The selection information may be provided as a header in the content disc(s) or media feed stream.

It is intended that the specification and examples disclose herein be considered as exemplary only, with a true scope and spirit of the invention being indicated by the following claims.

What is claimed is:

1. A method of receiving consumer entertainment content coupled with advertisements, comprising:
receiving entertainment content pre-recorded on a first medium;
receiving advertisements pre-recorded on a second medium;
inserting the first medium into a player device having multiple media capability;
inserting the second medium into the player device;
displaying the pre-recorded entertainment content from the first medium by the player device; and
displaying advertisements from the second medium by the player device, based on commands in the pre-recorded entertainment content derived from the first medium by the player device.

2. The method of claim 1, wherein receiving the second medium includes receiving the second medium with graphics, software upgrades, and navigation control software.

3. The method of claim 1, wherein displaying the pre-recorded entertainment content requires the second medium to be inserted into the player device.

4. The method of claim 1, comprising:
receiving additional advertisements pre-recorded on a third medium;
inserting the third medium into the player device; and
displaying advertisements from the third medium by the player device based on commands in the pre-recorded entertainment content derived from the first medium by the player device.

5. The method of claim 1, comprising:
receiving additional entertainment content pre-recorded on a third medium;
inserting the third medium; and
displaying the selected pre-recorded entertainment content from the third medium by the player device.

6. The method of claim 1, wherein displaying advertisements comprises displaying advertisement on a display mounted on the player device.

7. The method of claim 6, wherein displaying advertisements comprises displaying advertisements on a display remotely located from the player device.

8. The method of claim 1, wherein inserting the first and the second media comprises inserting the first and the second media into a player device comprising a dual reader and a single spindle.

9. The method of claim 8, wherein:
inserting the second medium comprises inserting the second medium on a lower level of the spindle and
inserting the first medium comprises inserting the first medium on an upper level of the spindle with one head of the dual reader being below the second medium and a second head of the dual reader being above the first medium.

10. The method of claim 1, comprising maintaining a library of the received entertainment content.

11. The method of claim 10, comprising providing, in the library, information associated with the received entertainment content, including at least a title and a time period during which the entertainment content may be viewed.

12. The method of claim 10, wherein maintaining the library comprises adding a title associated with the received entertainment content if it is not already in the library, and adding titles associated with packages of entertainment content as a group.

13. The method of claim 10, comprising managing the library through an interactive television interface.

14. The method of claim 1, comprising identifying a distribution channel associated with the entertainment content and crediting the distribution channel with the use of the entertainment content.

15. The method of claim 1, comprising maintaining a catalog of the entertainment content that is available for viewing.

16. The method of claim 15, comprising viewing the catalog through an interactive television interface and requesting, via the interactive television interface, entertainment content to be shipped to a consumer location.

17. The method of claim 16, comprising paying for requested entertainment content by selecting a product code, which is overlaid as on identification on the entertainment content, and transmitting the product code to a system operator.

18. The method of claim 1, comprising searching the advertisements on the second medium based on one of consumer established preferences and preferences deduced from consumer selections of entertainment content to provide advertisements that match the consumer preferences.

19. The method of claim 1, wherein displaying the entertainment content comprises displaying entertainment content based on a release date associated with the entertainment content.

20. The method of claim 1, wherein displaying advertisements comprises displaying advertisements based on a distribution date associated with the entertainment content.

21. The method of claim 1, wherein displaying advertisements comprises displaying advertisements based on environmental information provided to the player device.

22. The method of claim 1, wherein displaying advertisements comprises displaying advertisements based on one of a type associated with the entertainment content and a title associated with the entertainment content.

23. The method of claim 1, comprising using a biometric security feature to authorize consumers to view the entertainment content.

24. The method of claim 1, comprising receiving the second medium with at least one of the following: pricing information, predefined search information for use with a catalog, category information for organizing the entertainment content within the catalog, and information for consumers to participate in contests, games, and surveys.

25. The method of claim 15, comprising providing links in the catalog to relate consumer selected entertainment content to other related entertainment content and presenting the other related entertainment content to a consumer.

26. The method of claim 25, comprising using the links to limit, based on consumer preferences, the entertainment content from the catalog that will be presented to the consumer.

27. The method of claim 1, comprising ejecting the first medium via a remote control device, ejecting the second medium via a front panel control on the player device, and generating a reminder to insert the second medium into the player device.

28. The method of claim 1, comprising receiving navigational commands to the player device via a remote control device with a microphone.

29. The method of claim 28, comprising using one of voice-to-infrared translation and BlueTooth transmissions to communicate navigational commands from the remote control device to the player device.

30. The method of claim 1, comprising receiving navigational commands to the player device via a remote control device using infrared communications.

31. The method of claim 1, comprising receiving audio signals via a remote control device with a microphone and communicating the audio signals to the player device for insertion into the entertainment content as an audio clip.

32. The method of claim 1, comprising receiving audio signals via a remote control device with a microphone, communicating the audio signals to the player device, and playing the audio signals with pre-recorded audio in the entertainment content.

33. The method of claim 1, comprising receiving entertainment content with teaching and testing content for consumer use through an interactive interface, and comparing results from consumer use with national statistics.

34. The method of claim 1, comprising receiving entertainment content with at least one of surveys, contests, and games for consumer use through an interactive interface, and providing a reward to a consumer for using the entertainment content.

35. The method of claim 1, comprising transferring at least one of keys and rental and authorization rights from the player device to a portable device.

36. The method of claim 35, comprising transferring the keys and rental and authorization rights from the player device to the portable device using one of BlueTooth, miniature USB, and X10 transport.

37. The method of claim 1, comprising enabling and disabling CD-audio and DVD-video features via consumer input.

38. The method of claim 1, comprising acquiring authorization to view the received entertainment content by sending a request to a system operator and receiving the authorization from the system operator at the player device.

39. The method of claim 38, comprising providing the authorization with a player identification, a time stamp, and a random number to produce a unique authorization associated with a particular player device and entertainment content.

40. The method of claim 1, wherein displaying the entertainment content includes providing interactive consumer decision points for a consumer to select a playback order for the entertainment content.

41. The method of claim 1, comprising formatting the entertainment content in an altered data structure that is un-readable by conventional DVD and CD players.

42. A player device for generating audio visual signals representative of entertainment content with advertisements, comprising:
a first reader mechanism that reads entertainment content prerecorded on a first medium;
a second reader mechanism that reads advertisements pre-recorded on a second medium; and
a processor generating command signals that inserts advertisements from the second medium read by the second reader mechanism into entertainment content from the first medium read by the first reader mechanism.

43. The player device of claim 42, wherein the second medium includes graphics, software upgrades, and navigation control software.

44. The player device of claim 42, wherein the processor requires the second medium to be inserted into the player device before the first reader mechanism reads the entertainment content.

45. The player device of claim 42, comprising a mechanism for receiving a third medium and the first and second media, wherein the third medium contains additional pre-recorded advertisements, and wherein the processor generates command signals that insert advertisements from the third medium into entertainment content from the first medium.

46. The player device of claim 42, comprising a three disc carousel for receiving a third medium and the first and second media, wherein the third medium contains additional pre-recorded entertainment content and one of the first and second reader mechanisms is used to read the entertainment content from the third medium.

47. The player device of claim 42, wherein the player device comprises a display mounted on the player device for displaying advertisements.

48. The player device of claim 47, wherein comprises a display remotely located from the player device.

49. The player device of claim 42, wherein the player device comprises a dual reader and one spindle.

50. The player device of claim 49, wherein the second medium is located on a lower level of the spindle and the first medium is located on an upper level of the spindle with the second reader mechanism being below the second medium and the first reader mechanism being above the first medium.

51. The player device of claim 42, wherein the player device comprises a library of the entertainment content distributed to a consumer location.

52. The player device of claim 51, wherein the library contains information defining the entertainment content distributed to the consumer location including at least a title and a time period that a consumer may view the entertainment content.

53. The player device of claim 51, wherein the library comprises titles associated with the specific entertainment content, and titles associated with packages of entertainment content as a group.

54. The player device of claim 51, comprising an interactive television interface for managing the library.

55. The player device of claim 42, wherein the player device comprises a catalog of the entertainment content that is available for viewing.

56. The player device of claim 55, comprising an interactive interface for displaying the catalog and for receiving requests for entertainment content to be shipped to a consumer location.

57. The player device of claim 56, comprising means for displaying product codes overlaid as identifications on the entertainment content, means for receiving a displayed product code via the interactive interface, and means for transmitting the product code to a system operator.

58. The player device of claim 42, comprising means for selecting advertisements on the second medium based on one of consumer established preferences and preferences deduced from consumer selections of entertainment content, to provide advertisements that match the consumer preferences.

59. The player device of claim 42, wherein the player device displays advertisements based on a distribution date associated with the entertainment content.

60. The player device of claim 42, wherein the player device displays the entertainment content based on a release date associated with the entertainment content.

61. The player device of claim 42, wherein the player device displays advertisements based on environmental information provided to the player device.

62. The player device of claim 42, wherein the player device displays advertisements based on one of a type associated with the entertainment content and a title associated with the entertainment content.

63. The player device of claim 42, comprising means for providing authorization for a consumer to view the entertainment content through the use of a biometric security feature.

64. The player device of claim 42, wherein the second medium contains at least one of the following: pricing information, predefined search information for use with a catalog, category information for organizing the entertainment content within the catalog, and information for consumers to participate in contests, games, and surveys.

65. The player device of claim 55, comprising links in the catalog to relate consumer selected entertainment content to other related entertainment content, and means for presenting the other related entertainment content to a consumer.

66. The player device of claim 65, wherein the links limit, based on the consumer's preferences, the entertainment content from the catalog that will be presented to the consumer.

67. The player device of claim 42, wherein the player device comprises a remote control for ejecting the first medium, a front panel control for ejecting the second medium, and means for providing a reminder to insert the second medium into the player device.

68. The player device of claim 42, wherein the player device comprises a remote control with a microphone for communicating navigational commands to the player device.

69. The player device of claim 68, wherein the remote control uses one of voice-to-infrared translation and BlueTooth transmissions for communicating navigational commands to the player device.

70. The player device of claim 42, wherein the player device comprises a remote control for communicating navigational commands to the player device using infrared communications.

71. The player device of claim 42, wherein the player device comprises a remote control with a microphone that communicates audio signals to the player device for insertion into the entertainment content as an audio clip.

72. The player device of claim 42, wherein the player device comprises a remote control with a microphone that communicates audio signals to the player device and for playback with audio in the entertainment content.

73. The player device of claim 42, wherein the entertainment content includes teaching and testing content for consumer use through an interactive interface, and results from the consumer's usage are compared to national statistics.

74. The player device of claim 42, wherein the entertainment content includes one of surveys, contests, and games for consumer use through an interactive interface, and means for providing a reward to the consumer for using the entertainment content.

75. The player device of claim 42, wherein the player comprises an associated portable device and a circuit for transferring keys and rental and authorization rights to the portable device.

76. The player device of claim 75, wherein the circuit transfers keys and rental and authorization rights to the portable device using one of BlueTooth, miniature USB, and X10 transport.

77. The player device of claim 42, wherein the player device comprises a control to enable and disable CD-audio and DVD-video features for the player device.

78. The player device of claim 42, comprising an interactive interface to send a consumer authorization request to a system operator and to receive the authorization from the system operator.

79. The player device of claim 78, wherein the authorization contains a player identification, a time stamp, and a random number to produce a unique authorization associated with a particular player device and entertainment content.

80. The player device of claim 42, wherein the player device generates interactive consumer decision points for a consumer to select a playback order for the entertainment content.

81. The player device of claim 42, wherein the entertainment content is formatted in an altered data structure that is un-readable by conventional DVD and CD players.

82. A player device for generating audio visual signals representative of entertainment content with advertisements, comprising:
a first reader mechanism for reading entertainment content prerecorded on a first medium;
a second reader mechanism for reading advertisements pre-recorded on a second medium; and
a processor generating: i) command signals inserting advertisements from the second medium read by the second reader mechanism into the entertainment content from the first medium read by the first reader mechanism; and ii) at least one watermark that is inserted into the entertainment content.

83. The player device of claim 82, wherein the second medium includes graphics, software upgrades, and navigation control software.

84. The player device of claim 82, wherein the processor generates the at least one watermark for the entertainment content using at least one randomized parameter.

85. The player device of claim 84, wherein the at least one randomized parameter is selected from a group consisting of a frame location and a temporal spread between two of the at least one watermark.

86. The player device of claim 85, wherein the temporal spread between any two adjacent watermarks is less than a maximum temporal spread.

87. The player device of claim 85, wherein the temporal spread between any two adjacent watermarks is greater than a minimum temporal spread.

88. The player device of claim 82, wherein the at least one watermark is added to the entertainment content during a stage selected from a group consisting of during encoding, during decoding, before encoding, after encoding, after decoding, and a combination thereof.

89. The player device of claim 82, wherein the at least one watermark includes a unique transaction code.

90. The player device of claim 89, wherein the transaction code is scrambled before the at least one watermark is inserted into the entertainment content.

91. The player device of claim 89, wherein the transaction code is altered before the at least one watermark is inserted into the entertainment content to improve code survivability during one of analog to digital conversion, digital to analog conversion, and compression.

92. The player device of claim 82, wherein the at least one watermark is inserted in the entertainment content in a manner rendering the watermark invisible during playback at an ordinary viewing speed.

93. The player device of claim 82, wherein the at least one watermark is placed in a manner that reduces a viewers perceptual awareness of the at least one watermark.

94. A method of providing a consumer with entertainment content coupled with advertisements, comprising:
receiving entertainment content pre-recorded on a first medium;
receiving advertisement content pre-recorded on a second medium;
inserting the first medium into a player device;
inserting the second medium content into the player device; and
displaying the entertainment content with at least one watermark and with advertisements from the second medium.

95. The method of claim 94, wherein receiving the second medium includes receiving the second medium with graphics, software upgrades, and navigation control software.

96. The method of claim 94, wherein displaying the entertainment content comprises adding the at least one watermark to the entertainment content using at least one randomized parameter.

97. The method of claim 96, comprising selecting the at least one randomized parameter from a group consisting of a frame location and a temporal spread between two of the at least one watermark.

98. The method of claim 97, comprising providing the temporal spread between any two adjacent watermarks with less than a maximum temporal spread.

99. The method of claim 97, comprising providing the temporal spread between any two adjacent watermarks with greater than a minimum temporal spread.

100. The method of claim 94, comprising adding the at least one watermark to the entertainment content during a stage selected from a group consisting of during encoding, during decoding, before encoding, after encoding, after decoding, and a combination thereof.

101. The method of claim 94, comprising providing the at least one watermark with a unique transaction code.

102. The method of claim 101, comprising scrambling the transaction code before adding the at least one watermark to the entertainment content.

103. The method of claim 101, comprising altering the transaction code before adding the at least one watermark to the entertainment content to improve code survivability during one of analog to digital conversion, digital to analog conversion, and compression.

104. The method of claim 94, comprising inserting the at least one watermark into the entertainment content in a manner that the at least one watermark is invisible during playback at an ordinary viewing speed.

105. The method of claim 94, comprising inserting the at least one watermark into the entertainment content in at least a partial random manner.

106. The method of claim 94, comprising inserting the at least one watermark in a manner that reduces a viewers perceptual awareness of the at least one watermark.

107. A method for displaying entertainment content in a projector system, comprising:
receiving a plurality of content discs containing pre-recorded entertainment content;
receiving at least one advertisement disc;
reading first data from the content discs in a predetermined order;
reading second data from the advertisement disc;
transferring the first and second data to a storage device; and
displaying the transferred first and second data on the projection system.

108. The method of claim 107, wherein displaying the transferred first and second data comprises displaying the transferred second data based on commands contained in the first data.

109. The method of claim 107, wherein transferring the first and second data to the storage device includes transferring the first and second data to one of a hard drive and an optical disk.

110. The method of claim 108, wherein displaying the second data comprises displaying the second data based on a distribution date associated with entertainment content in at least one of the plurality of content discs.

111. The method of claim 108, wherein displaying the second data comprises displaying the second data based on environmental information provided to the player device.

112. The method of claim 108, wherein displaying the second data comprises displaying the second data based on one of a type and a title associated with the entertainment content in at least one of the plurality of content discs.

113. The method of claim 107, comprising communicating navigational commands to the player device from a remote control with a microphone.

114. The method of claim 113, comprising using one of voice-to-infrared translation and BlueTooth transmissions for communicating navigational commands from the remote control to the player device.

115. The method of claim 107, comprising communicating navigational commands to the player device from a remote control using infrared communications.

116. A system for providing entertainment content in a projector system, comprising:
a multi-disc tray for receiving at least one content disc and at least one advertisement disc;
at least one reading mechanism;
a processor that instructs the at least one reading mechanism to read data from at least one content disc and at least one advertisement disc in a predetermined order;
a storage device that receives the data read from the discs; and
a projection system that displays the data from the storage device.

117. The system of claim 116, wherein advertisements and the advertisements are displayed based on commands in at least one of the content discs.

118. The system of claim 116, wherein the storage device is one of a hard drive and an optical disk.

119. The system of claim 117, wherein the advertisements are displayed based on a distribution date associated with entertainment content in at least one of the plurality of content discs.

120. The system of claim 117, wherein the advertisements are displayed based on environmental information provided to the player device.

121. The system of claim 117, wherein the advertisements are displayed based on one of a type and a title associated with the entertainment content in at least one of the plurality of content discs.

122. The system of claim 116, comprising a remote control including a microphone for communicating navigational commands to the player device.

123. The system of claim 116, wherein the remote control uses one of voice-to-infrared translation and BlueTooth transmissions for communicating navigational commands from the remote control to the player device.

124. The system of claim 116, comprising a remote control for communicating navigational commands to the player device using infrared communications.
